(19) United States
(12) Patent Application Publication
(10) Pub. No.: US 2024/0373239 A1
(43) Pub. Date: Nov. 7, 2024

(54) COMMUNICATION CONTROL DEVICE, COMMUNICATION DEVICE, AND COMMUNICATION CONTROL METHOD

(71) Applicant: SONY GROUP CORPORATION, TOKYO (JP)

(72) Inventor: SHO FURUICHI, TOKYO (JP)

(21) Appl. No.: 18/263,412

(22) PCT Filed: Jan. 21, 2022
(86) PCT No.: PCT/JP2022/002281

§ 371 Date: Jul. 28, 2023

(30) Foreign Application Priority Data
Feb. 8, 2021 (JP) 2021-018470

(51) Int. Cl. H04W 16/14; H04W 74/0808

(52) U.S. Cl. CPC H04W 16/14; H04W 74/0808

(57) ABSTRACT

[Problem] An interference margin allocation method in consideration of communication between communication devices is provided.

[Solution] A communication control device of the present disclosure includes a calculator by which one or more first communication device groups for which a plurality of first time resources for communication are synchronized with each other calculate a first cumulative interference power, which is the sum of interference powers applied to a protection target system, in units of the first time resources, and a processor configured to determine an interference margin indicating an interference power allowable for communication devices of the one or more first communication device groups on the basis of the first cumulative interference power.

### TECHNICAL FIELD

The present disclosure relates to a communication control device, a communication device, and a communication control method.

### BACKGROUND ART

The problem of depletion of radio wave resources (frequencies) that can be allocated to wireless systems has surfaced. “Dynamic Spectrum Access (DSA)” is attracting attention as a means of generating necessary radio resources.

### CITATION LIST

### Non Patent Literature

### [NPL 1]

WINNF-TS-0112-V1.9.1 “Requirements for Commercial Operation in the U.S. 3550-3700 MHz Citizens Broadband Radio Service Band”

### [NPL 2]

Electronic Code of Federal Regulations, Title 47, Chapter I, Subchapter A, Part 1, Subpart X Spectrum Leasing [available at https://www.ecfr.gov/cgi-bin/text-idx?node=sp47.1.1.x]

### [NPL 3]

WINNF-TS-0061-V1.5.1 Test and Certification for Citizens Broadband Radio Service (CBRS); Conformance and Performance Test Technical Specification; SAS as Unit Under Test (UUT) [available at https://cbrs.wirelessinnovation.org/release-1-of-the-baseline-standard-specifications]

### [NPL 4]

WINNF-TS-0016-V1.2.4 Signaling Protocols and Procedures for Citizens Broadband Radio Service (CBRS): Spectrum Access System (SAS)-Citizens Broadband Radio Service Device (CBSD) Interface Technical Specification [available at https://cbrs.wirelessinnovation.org/release-1-of-the-baseline-standard-specifications]

### [NPL 5]

940660 D02 CBSD Handshake Procedures v02 [available at https://apps.fcc.gov/kdb/GetAttachment.html?id=RQe7oZJVSWtOfCcNiBV % 2Bfw %3D%3D&desc=940660% 20D02%20CPE-CBSD %20Handshake%20Procedures%20v02&tracking_number=229297]

### Patent Literature

### [PTL 1]

JP 6361661B

### SUMMARY

### Technical Problem

NPL 1 discloses an algorithm for calculating a list of spectrum grants (simply called grants) called a Move List as a method for protecting a radar, which is a primary system in a Citizens Broadband Radio Service (CBRS). A CBSD having a spectrum grant included in the Move List is instructed by the Spectrum Access System (SAS) to which radar signal detection is signaled by environmental sensing capability (ESC) to temporarily stop radio wave transmission or to move to another frequency channel (re-acquire a spectrum grant) based on the grant during a period for which the radar uses a frequency. A set of spectrum grants other than the Move List is called a Keep List. Radio wave transmissions associated with grants included in the Keep List are permitted as long as the cumulative sum of radio wave interference for each CBSD does not exceed an allowable interference power level, and the amount of radio wave interference allowed for each CBSD corresponds to an interference margin. Therefore, the Keep List can be considered as an interference margin allocation technique for radar protection. The Move List and the Keep List are calculated in the following procedure.
(1) CBSD spectrum grants located within a cumulative interference power calculation target area (also called a neighborhood area) are identified.
(2) A power level of single entry interference applied to a dynamic protection area (DPA) is calculated on the basis of the identified spectrum grants.
(3) Power levels of single entry interference are sorted in ascending order, and the cumulative sum is calculated in order from the minimum value.
(4) A set of maximum spectrum grants whose cumulative sum does not exceed the allowable interference power level is set as the Keep List.
(5) A set of all spectrum grants that are not included in the Keep List is set as the Move List.

Further, in order to protect a fixed satellite service (FSS) earth station for Telemetry, Tracking and Command (TT&C) that exists in the 3700 MHz band (C band), an algorithm for calculating a list of spectrum grants called a Purge List with the same concept as the Move List has also been disclosed. The basic calculation method is the same as the Move List, but the difference is that, in single entry interference power calculation, an out-of-band emission limit (OOBE limit) defined by FCC regulations is calculated as a transmission power. Further, unlike the Move List, all spectrum grants included in the Purge List must be discarded when use of frequencies by a radar or the like is detected.

In addition, an interference margin allocation method called an iterative allocation process (IAP) for protecting other protection target systems in CBRS, such as an FSS earth station, PAL protection area (PPA), ESC sensor, and Grandfathered Wireless Protection Zone (GWPZ), has been defined.

Here, the Move List, Purge List, and IAP still have some points to be improved. One of them is consideration of functions and operation modes of CBSDs. The protection requirements and algorithms defined in NPL 1 assume a conventional mobile network in which a base station (=CBSD) provides services to a terminal (=EUD). As specified in Part 96, the SAS does not need to manage EUD, and thus EUD is not considered in various protection requirements and algorithms, and all CBSD spectrum grants are considered as interference sources.

On the other hand, the CBRS also allows communication between CBSDs and, for example, communication between CBSDs is used to establish a fixed wireless access (FWA) network. Here, it is conceivable to perform wireless communication between CBSDs using the following communication method.
Time division communication/channel access (TDD, TDMA, etc.)
Frequency division communication/channel access (FDMA, OFDMA, etc.)
Spatial division communication/channel access (SDMA, multi-user MIMO, etc.)
Collision-based channel access (LBT, CSMA/CA, etc.)
Combinations of the above

When a plurality of CBSDs communicating with each other by such a communication method are present, all the CBSDs do not necessarily radiate radio waves at the same time. In this case, considering all CBSD spectrum grants as interference sources as before, excessive operational restrictions are imposed, that is, more spectrum grants than necessary are stored in the Move List or the Purge List. In the IAP, there is a risk that a transmission power will be excessively restricted.

PTL 1 discloses an invention regarding an interference margin allocation method based on the number of secondary systems. PTL 1 describes a method of counting only the number of devices which are master devices as the number of secondary systems when the secondary systems are operated in a time division method and slave devices use transmission power the same as (or lower than) that of the master device as an example of a method of counting the number of secondary systems which is considered in power control for protecting a primary system. Further, for example, if master devices and slave devices can transmit signals at the same time, ensuring safe power calculation by counting the number of devices of both the master devices and the slave devices as the number of secondary systems is also mentioned.

Furthermore, PTL 1 also describes a method of performing calculations by including weights depending on a device configuration (e.g., one or more of an antenna height, a transmission power (which is a maximum or that desired, or may be an assigned transmission power for existing devices), and a frequency channels to be used).

Either method is an example considering whether or not a plurality of devices will interfere with a primary system at the same time.

The above-described methods are considered to be effective when CBSDs perform time division communication (TDD, TDMA, etc.). However, it is not effective for a combination of the above-described communication methods.

Therefore, the present disclosure provides a communication control device, a communication device, and a communication control method that enable effective utilization of frequency bands.

### Solution to Problem

A communication control device of the present disclosure includes a calculator by which one or more first communication device groups for which a plurality of first time resources for communication are synchronized with each other calculate a first cumulative interference power, which is the sum of interference powers applied to a protection target system, in units of the first time resources, and a processor configured to determine an interference margin indicating an interference power allowable for communication devices of the one or more first communication device groups on the basis of the first cumulative interference power.

A communication control method of the present disclosure includes calculating, by one or more first communication device groups for which a plurality of first time resources for communication are synchronized with each other, a first cumulative interference power which is the sum of interference powers applied to a protection target system in units of the first time resources, and determining an interference margin indicating an interference power allowable for communication devices of the one or more first communication device groups on the basis of the first cumulative interference power.

A communication control device of the present disclosure includes a processor configured to divide a plurality of communication devices that perform random access communication on the basis of carrier sensing from a radio medium into a plurality of groups in a relationship in which communication devices belonging to the same group do not detect radio waves each other, and a calculator configured to calculate a cumulative interference power that is the sum of interference powers given to the protection target system by the groups, wherein the processor determines interference margins for the communication devices belonging to the groups on the basis of the cumulative interference power for each group.

A communication device of the present disclosure is a communication device in one or more first communication device groups for which a plurality of first time resources for communication are synchronized with each other, wherein the sum of an interference power applied to a protection target system by radio waves transmitted by the communication device using an arbitrary first time resource among the plurality of first time resources and an interference power applied to the protection target system by radio waves transmitted by another communication device in the first communication device groups using the arbitrary first time resource is equal to or less than an interference power value allowed for the protection target system.

### BRIEF DESCRIPTION OF DRAWINGS

FIG. 1 is a diagram showing a system model in an embodiment of the present disclosure.

FIG. 2 is a diagram showing a network configuration to which autonomous decision-making can be applied.

FIG. 3 is a diagram showing a network configuration to which centralized decision-making can be applied.

FIG. 4 is a diagram showing a network configuration when both centralized decision-making and distributed decision-making are applied.

FIG. 5 is a diagram illustrating a 3-tier structure in a CBRS.

FIG. 6 is a diagram illustrating a flow of signaling between terminals.

FIG. 7 is a block diagram of a communication network according to an embodiment of the present disclosure.

FIG. 8 is a diagram showing a relationship between frequency and time when a CPE-CBSD performs time division communication with a BTS-CBSD.

FIG. 9 is a flowchart showing an operation example of a communication control device according to an embodiment of the present disclosure.

FIG. 10 is a conceptual diagram regarding allocation of interference margins.

FIG. 11 is a diagram showing a specific example of allocation of interference margins.

FIG. 12 is a diagram showing an example in which there are asynchronous pairs when there are a plurality of BTS-CBSD and CPE-CBSD pairs that can be interference sources.

FIG. 13 is a flowchart of an example of the operation of the communication control device according to the present embodiment.

FIG. 14 is a diagram showing a relationship between frequency and time when a single CPE-CBSD performs time division communication with a plurality of BTS-CBSDs.

FIG. 15 is a diagram showing a relationship between frequency and time when a plurality of CPE-CBSDs perform frequency multiplex communication with a BTS-CBSD.

FIG. 16 is a supplementary explanatory diagram of FIG. 15.

FIG. 17 is a diagram showing a relationship between space, frequency, and time when a plurality of communication devices perform spatial multiplex communication.

FIG. 18 is a diagram showing an arrangement example of communication devices that can interfere with each other.

FIG. 19 is a diagram showing another arrangement example of communication devices that can interfere with each other.

FIG. 20 is a graph showing a relationship between communication devices that can interfere with each other.

FIG. 21 is a diagram in which a pattern for identifying a group to which a communication device belongs is attached to the vertex of the graph of FIG. 20.

### DESCRIPTION OF EMBODIMENTS

### 1. Assumed Representative Scenario

### <1.1 System Model>

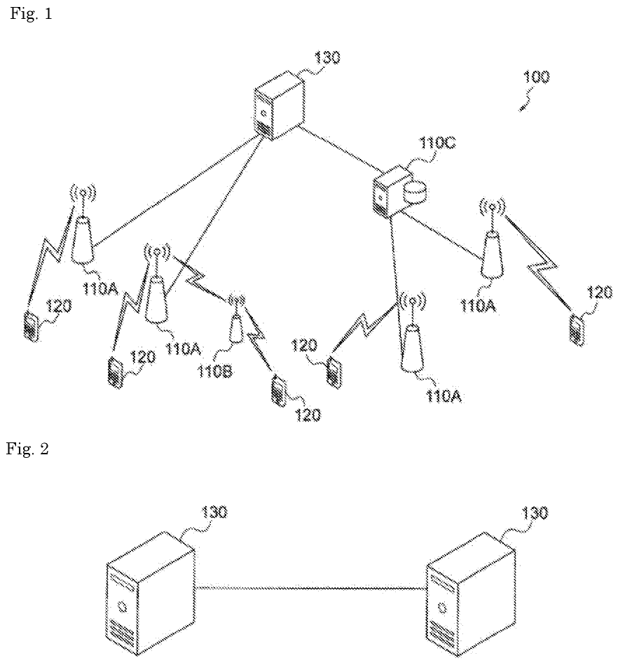

FIG. 1 shows a system model in an embodiment of the present invention. This system model is represented by a communication network 100 including wireless communication, as shown in FIG. 1, and is typically composed of the following entities.
Communication device 110
Terminal 120
Communication control device 130

In addition, this system model includes at least a primary system and a secondary system that use the communication network 100. The primary system and the secondary system are configured by the communication device 110 or by the communication device 110 and the terminal 120. Although various communication systems can be handled as a primary system or a secondary system, it is assumed in the present embodiment that a primary system and a secondary system use some or all of frequency bands. Frequency bands assigned to the primary system and the secondary system may partially or wholly overlap, or may not overlap at all. That is, this system model will be described as a model of a wireless communication system regarding dynamic spectrum access (DSA). This system model is not limited to systems related to dynamic spectrum access.

The communication device 110 is typically a radio device that provides a radio communication service to the terminal 120, such as a wireless base station (base station, Node B, eNB, gNB, or the like) or a radio access point. That is, the communication device 110 provides the wireless communication service to enable wireless communication of the terminal 120. Further, the communication device 110 may be a radio relay device or an optical extension device called a remote radio head (RRH). In the following description, the communication device 110 will be described as an entity constituting a secondary system unless otherwise specified.

A coverage (communication area) provided by the communication device 110 is allowed to have various sizes, from a large one like a macrocell to a small one like a picocell. A plurality of communication devices 110 may form one cell like a distributed antenna system (DAS). Further, if the communication device 110 has beamforming capability, a cell or a service area may be formed for each beam.

In the present disclosure, it is assumed that there are two different types of communication devices 110.

In the present disclosure, a communication device 110 that can access the communication control device 130 without using a wireless path that requires grant of the communication control device 130 is referred to as “communication device 110A”. Specifically, for example, a communication device 110 capable of connecting to the Internet by wire can be regarded as the “communication device 110A”. Further, for example, a radio relay device that does not have a wired Internet connection function may also be regarded as the “communication device 110A” if a wireless backhaul link using a frequency that does not require grant of the communication control device 130 is established between the radio relay device and another communication device 110A.

In the present disclosure, a communication device 110 that cannot access the communication control device 130 without a wireless path that requires grant of the communication control device 130 is referred to as a “communication device 110B”. For example, a radio relay device that needs to establish a backhaul link using a frequency that requires grant of the communication control device 130 can be regarded as the “communication device 110B”. Further, for example, a device such as a smartphone having a wireless network provision function represented by tethering and using a frequency that requires grant of the communication control device 130 in both a backhaul link and an access link may be handled as the “communication device 110B”.

The communication device 110 does not necessarily need to be fixedly installed. For example, the communication device 110 may be installed in a moving object such as an automobile. Further, the communication device 110 does not necessarily need to be present on the ground. For example, the communication device 110 may be provided on an object present in the air or space, such as an aircraft, a drone, a helicopter, a high altitude platform station (HAPS), a balloon, or a satellite. Further, the communication device 110 may be provided on an object on or under the sea, such as a ship, a submarine, or the like, for example. Typically, such a mobile communication device 110 corresponds to the communication device 110B and secures an access route to the communication control device 130 by performing wireless communication with a communication device 110A. As a matter of course, if the frequency used for wireless communication with the communication device 110A is not managed by the communication control device 130, nevertheless the mobile communication device 110 can be handled as the communication device 110A.

In the present disclosure, description of “communication device 110” encompasses the meaning of both the communication device 110A and the communication device 110B and may be read as either unless otherwise specified.

The communication device 110 can be used, operated, or managed by various operators. For example, a mobile network operator (MNO), a mobile virtual network operator (MVNO), a mobile network enabler (MNE), a mobile virtual network enabler (MVNE), a common facility operator, a neutral host network (NHN) operator, broadcasters, enterprises, educational institutions (school corporations, each local government board of education, etc.), real estate (buildings, condominiums, etc.) administrators, individuals, and the like can be assumed as operators regarding the communication device 110. Operators regarding the communication device 110 are not particularly limited. Further, the communication device 110A may be a common facility used by a plurality of operators. Further, different operators may install, use, operate, and manage facilities.

The communication device 110 operated by an operator is typically connected to the Internet via a core network. In addition, operation, management, and maintenance are performed by a function called OA&M (Operation, Administration & Maintenance). Further, for example, as shown in FIG. 1, there may be an intermediate device (network manager) 110C that integrally controls the communication devices 110 in a network. The intermediate device may be the communication device 110 or may be the communication control device 130.

The terminal 120 (user equipment, user terminal, user station, mobile terminal, mobile station, or the like) is a device that performs wireless communication through the wireless communication service provided by the communication device 110. Typically, a communication apparatus such as a smartphone corresponds to the terminal 120. Any device having a wireless communication function can correspond to the terminal 120. For example, an apparatus such as a camera for business use that has a wireless communication function may correspond to the terminal 120 even if wireless communication is not a main purpose. In addition, a communication apparatus that transmits data to the terminal 120, such as a field pickup unit (FPU) that transmits images for television broadcasting, and the like from the outside of a broadcasting station (site) to the broadcasting station in order to perform sports relay and the like, also corresponds to the terminal 120. Further, the terminal 120 does not necessarily need to be used by a person. For example, like so-called machine type communication (MTC), an apparatus such as a machine in a factory or a sensor installed in a building may be network-connected and operate as the terminal 120. Further, an apparatus called customer premises equipment (CPE) provided to ensure Internet connection may serve as the terminal 120.

Further, the terminal 120 may have a relay communication function, as represented by D2D (Device-to-Device) and V2X (Vehicle-to-Everything).

Further, similarly to the communication device 110, the terminal 120 does not necessarily need to be fixedly installed or present on the ground. For example, an object present in the air or space, such as an aircraft, a drone, a helicopter, or a satellite, may operate as the terminal 120. Further, for example, an object present on or under the sea, such as a ship or a submarine, may operate as the terminal 120.

In the present disclosure, the terminal 120 corresponds to an entity that terminates a radio link using a frequency that requires grant of the communication control device 130 unless otherwise specified. However, the terminal 120 can operate in the same manner as the communication device 110 depending on functions of the terminal 120 and a network topology applied thereto. In other words, depending on the network topology, a device such as a radio access point that can correspond to the communication device 110 may correspond to the terminal 120, and a device such as a smartphone that can correspond to the terminal 120 may correspond to the communication device 110.

The communication control device 130 is typically a device that performs determination, granting use, indication, and/or management of communication parameters for the communication device 110. For example, database servers called a TV white space database (TVWSDB), a geolocation database (GLDB), the Spectrum Access System (SAS), and automated frequency coordination (AFC) correspond to the communication control device 130. In other words, a database server having the authority and role such as authentication and supervision of radio wave use related to secondary use of frequencies can be regarded as the communication control device 130.

The communication control device 130 also corresponds to a database server having a role different from the above-described role. For example, a control device that performs radio wave interference control between communication devices, represented by a spectrum manager (SM) in EN 303 387 of European Telecommunications Standards Institute (ETSI), a coexistence manager (CM) in Institute of Electrical and Electronics Engineers (IEEE) 802.19.1-2018, a coexistence manager (CxM) in CBRSA-TS-2001, or the like, also corresponds to the communication control device 130. Further, for example, a registered location secure server (RLSS) specified by IEEE 802.11-2016 also corresponds to the communication control device 130. That is, the entity in charge of determination, use grant, indication, management, and the like of communication parameters for the communication device 110 may be called the communication control device 130 without being limited to these examples. Basically, a control target of the communication control device 130 is the communication device 110, but the communication control device 130 may control the terminal 120 under the control of the communication device 110.

The communication control device 130 also corresponds to a combination of a plurality of database servers having different roles. For example, CBRS Alliance SAS (CSAS), which is a combination of the SAS and CxM in CBRSA-TS-2001, can also be regarded as the communication control device 130.

The communication control device 130 can also be realized by implementing software having functions equivalent to those of the above-described database servers for one database server. For example, an SAS having CxM-equivalent functions or software can also be regarded as the communication control device 130.

A plurality of communication control devices 130 having similar roles may be present. When there are a plurality of communication control devices 130 having similar roles, at least one of the following three types of decision-making topologies can be applied to the communication control devices 130.
Autonomous Decision-Making
Centralized Decision-Making
Distributed Decision-Making

Autonomous decision-making is a decision-making topology in which an entity that performs decision-making (decision-making entity, the communication control device 130 here) makes a decision independently of another decision-making entity. The communication control device 130 independently performs necessary frequency allocation and interference control calculation. For example, when a plurality of communication control devices 130 are distributed as shown in FIG. 2, autonomous decision making can be applied.

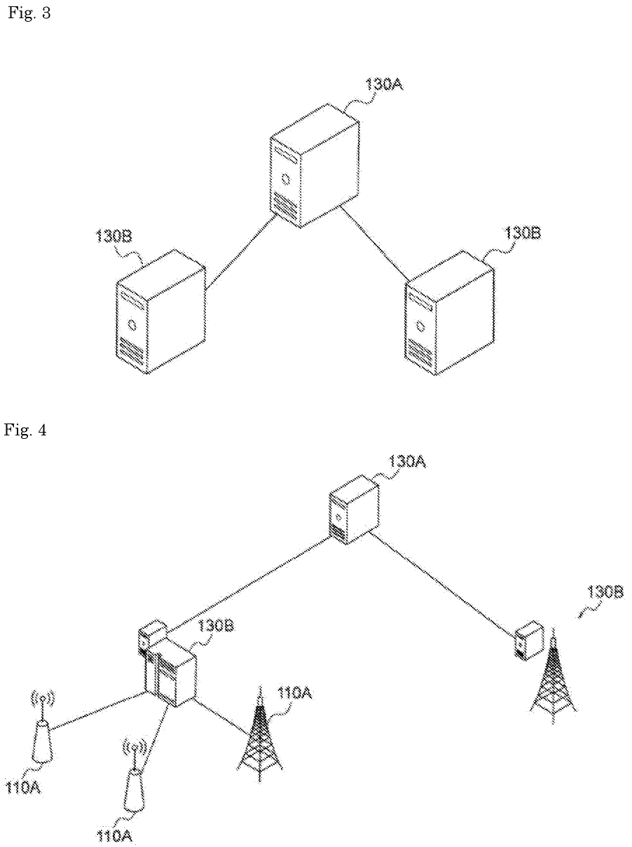

Centralized decision-making is a decision-making topology in which a decision-making entity delegates decision-making to another decision making entity. When centralized decision-making is performed, for example, a model such as that shown in FIG. 3 is assumed. FIG. 3 shows a model (so-called a master-slave type) in which one communication control device 130 centrally controls a plurality of communication control devices 130. In the model of FIG. 3, a master communication control device 130A can control a plurality of slave communication control devices 130B and make decisions intensively.

Distributed decision-making is a decision-making topology in which a decision-making entity cooperates with another decision-making entity to make decisions. For example, a plurality of communication control devices 130 make decisions independently as in autonomous decision-making shown in FIG. 3, but each communication control device 130 performs mutual adjustment, negotiation, and the like of results of decision-making after decision-making in “distributed decision-making”. Further, for example, in centralized decision-making shown in FIG. 3, the operation in which the master communication control device 130A dynamically performs delegation or cancellation of decision-making authority, and the like for each slave communication control device 130B for the purpose of load distribution (load balancing) can also be regarded as “distributed decision-making”.

Both centralized decision-making and distributed decision-making may be applied. In FIG. 4, a slave communication control device 130B operates as an intermediate device that bundles a plurality of communication devices 110 together. The master communication control device 130A may not control the communication devices 110 bundled by the slave communication control device 130B, that is, a secondary system configured by the slave communication control device 130B. In this manner, as a modified example, implementation as shown in FIG. 4 is also possible.

For its role, the communication control device 130 can also obtain necessary information from entities other than communication devices 110 and terminals 120 of the communication network 100. Specifically, for example, information necessary to protect a primary system can be obtained from a database (regulatory database) managed or operated by a national or regional radio regulatory authority (NRA: National Regulatory Authority). As an example of the regulatory database, a universal licensing system (ULS) operated by the Federal Communications Commissions (FCC) of the United States, or the like is conceivable. Examples of the information necessary to protect the primary system include position information of the primary system, communication parameters of the primary system, out-of-band emission (OOBE) limit, an adjacent channel leakage ratio (ACLR), adjacent channel selectivity, a fading margin, a protection ratio (PR), and the like, for example. In regions where fixed numerical values, acquisition methods, derivation methods, and the like are stipulated by laws and the like in order to protect the primary system, it is desirable to use information stipulated by the laws as information necessary to protect the primary system.

A database that records communication devices 110 and terminals 120 that have received conformance certification, such as an equipment authorization system (EAS) managed by Office of Engineering and Technology (OET) of the FCC also corresponds to the regulatory database. From such a regulatory database, it is possible to acquire information on operable frequencies of the communication devices 110 and the terminals 120, information on maximum equivalent isotropic radiated power (EIRP), and the like. Of course, the communication control device 130 may use such information to protect the primary system.

In addition, it can also be assumed that the communication control device 130 acquires radio wave sensing information from a radio wave sensing system installed and operated for the purpose of radio wave detection of the primary system. As a specific example, in Citizens Broadband Radio Service (CBRS) of the United States, the communication control device 130 acquires radio waves detection information of a shipboard radar that is a primary system from a radio wave sensing system called an environmental sensing capability (ESC). Further, if the communication device 110 or the terminal 120 has a sensing function, the communication control device 130 may acquire radio wave detection information of the primary system from them.

Further, it can be assumed that the communication control device 130 acquires activity information of the primary system from a portal system that manages the activity information of the primary system. As a specific example, in Citizens Broadband Radio Service (CBRS) of the United States, the communication control device 130 acquires the activity information of the primary system from a calendar type system called Informing Incumbent Portal. A protection area called a dynamic protection area (DPA) is activated on the basis of the acquired activity information to protect the primary system. An equivalent system called Informing Incumbent Capability (IIC) also realizes protection for the primary system in a similar manner.

An interface between entities constituting this system model may be wired or wireless. For example, an interface between the communication control device 130 and the communication device 110 may use not only a wired line but also a radio interface that does not depend on frequency sharing. Examples of the radio interface that does not depend on frequency sharing include, for example, wireless communication lines provided by mobile communication carriers via licensed bands, Wi-Fi communication using existing license-exempt bands, and the like.

### <1.2 Terminology Regarding Frequency and Sharing>

As described above, the present embodiment will be described assuming a dynamic spectrum access environment. As a representative example of dynamic frequency sharing, a mechanism defined by CBRS in the United States (that is, the mechanism defined by Part 96 Citizens Broadband Radio Service of FCC rules in the United States) will be described.

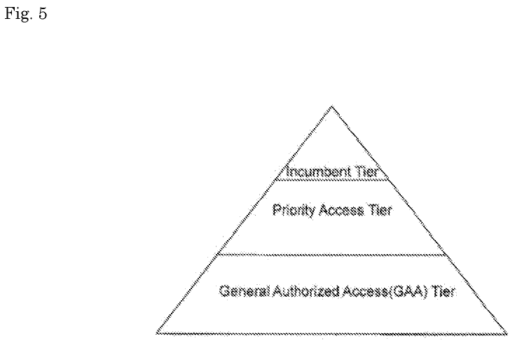

In the CBRS, each user of a frequency band is classified into one of three groups, as shown in FIG. 5. This group is called a tier. The three groups are called an incumbent tier, a priority access tier, and a general authorized access (GAA) tier.

The incumbent tier is a group of existing users who have been using a frequency band. Existing users are also generally referred to as primary users. In the CBRS, US Department of Defense (DOD), fixed satellite operators, and Grandfathered Wireless Broadband Licensees (GWBLs) are defined as existing users. The incumbent tier is not required to avoid interference with the priority access tier and the GAA tier, which have lower priority and to curb use of a frequency band. The incumbent tier is also protected from interference by the priority access tier and the GAA tier. That is, incumbent tier users can use the frequency band without considering the presence of other groups.

The priority access tier is a group of users who use a frequency band on the basis of the above-described priority access license (PAL). Priority access tier users are also generally referred to as secondary users. At the time of using a frequency band, the priority access tier is required to avoid interference and to curb use of the frequency band with respect to the incumbent tier which has a higher priority than the priority access tier. On the other hand, the GAA tier which has a lower priority than the priority access tier is not required to avoid interference and to curb use of the frequency band. Further, the priority access tier is not protected from interference by the incumbent tier which has a higher priority, but is protected from interference by the GAA tier which has a lower priority.

The GAA tier is a group of frequency band users who do not belong to the incumbent tier and the priority access tier. Similar to the priority access tier, GAA tier users are also generally referred to as secondary users. However, they are also called low-priority secondary users because they have a lower shared use priority than the priority access tier. At the time of using a frequency band, the GAA tier is required to avoid interference and to curb use of the frequency band with respect to the incumbent tier and the priority access tier which have higher priority. Further, the GAA tier is not protected from interference by the incumbent tier and the priority access tier which have higher priority.

Although the mechanism of the CBRS has been described above as a representative example of dynamic frequency sharing, the present embodiment is not limited to the definition of the CBRS. For example, the CBRS generally adopts a 3-tier structure, as shown in FIG. 5, but a 2-tier structure may be adopted in the present embodiment. Representative examples of the 2-tier structure include Authorized Shared Access (ASA), Licensed Shared Access (LSA), evolved LSA (eLSA), TV band White Space (TVWS), US 6 GHz band sharing, and the like. ASA, LSA, and eLSA do not have the GAA tier and adopt a structure equivalent to a combination of the incumbent tier and the priority access tier. In addition, TVWS and US 6 GHz band sharing do not have the priority access tier and adopt a structure equivalent to a combination of the incumbent tier and the GAA tier. Further, four or more tiers may be present. Specifically, four or more tiers may be generated by, for example, providing a plurality of intermediate tiers corresponding to the priority access tier and assigning different priorities to the respective intermediate tiers. In addition, for example, the GAA tier may be divided in the same manner and given priority to increase the number of tiers. That is, each group may be divided.

Further, the primary system of the present embodiment is not limited to the definition of the CBRS. As an example of the primary system, for example, a wireless system such as TV broadcasting, a fixed microwave line (fixed system (FS)), a meteorological radar, a radio altimeter, communications-based train control, or radio astronomy is assumed. Further, the primary system is not limited thereto, and any wireless system can be the primary system of the present embodiment.

In addition, as described above, the present embodiment is not limited to a frequency sharing environment. Generally, an existing system that uses a target frequency band is called a primary system and a secondary user is called a secondary system in frequency sharing or frequency secondary use, but they should be read in place of other terms when the present embodiment is applied to environments other than the frequency sharing environment. For example, a macro cell base station in a heterogeneous network (HetNet) may be a primary system, and a small cell base station or a relay station may be a secondary system. Further, a base station may be a primary system, and relay user equipment (UE) and vehicle UE that are present within the coverage of the base station and realize D2D and V2X may be secondary systems. The base station is not limited to a fixed type, and may be portable or mobile. In such a case, for example, the communication control device 130 of the present embodiment may be included in a core network, a base station, a relay station, relay UE, and the like.

Further, when the present embodiment is applied to environments other than the frequency sharing environment, the term “frequency” in the present disclosure is replaced by another term shared by an application destination. For example, it is assumed that the term is replaced by terms such as “resource”, “resource block”, “resource element”, “resource pool”, “channel”, “component carrier”, “carrier”, “subcarrier”, “bandwidth part (BWP)”, and other terms having an equivalent or similar meaning.

### 2. Description of Various Procedures Assumed in Present Embodiment

Here, basic procedures that can be used at the time of implementing the present embodiment will be described. Description up to <2.5> which will be described later will be made on the assumption that the procedures are mainly performed in the communication device 110A.

### <2.1 Registration Procedure>

A registration procedure is a procedure for registering information on a wireless system that intends to use a frequency band. More specifically, it is a procedure for registering device parameters regarding the communication device 110 of the wireless system in the communication control device 130. Typically, the registration procedure is started by the communication device 110, which represents the wireless system that intends to use the frequency band, signaling a registration request including device parameters to the communication control device 130. If a plurality of communication devices 110 belong to the wireless system that intends to use the frequency band, device parameters of each of the plurality of communication devices are included in the registration request.

Further, a device that transmits the registration request on behalf of the wireless system may be determined appropriately.

### <2.1.1 Details of Required Parameters>

Device parameters refer to, for example, the following information.
Information on a user of the communication device 110 (hereinafter referred to as user information)
Unique information of the communication device 110 (hereinafter referred to as unique information)
Information on the location of the communication device 110 (hereinafter referred to as location information)
Information on an antenna included in the communication device 110 (hereinafter referred to as antenna information)
Information on a radio interface included in the communication device 110 (hereinafter referred to as radio interface information)
Legal information on the communication device 110 (hereinafter referred to as legal information)
Information on an installer of the communication device 110 (hereinafter referred to as installer information)
Information on a group to which the communication device 110 belongs (hereinafter referred to as group information)

The device parameters are not limited to the above. Information other than these may be handled as device parameters. The device parameters do not need to be transmitted once and may be divided and transmitted a plurality of times. That is, a plurality of registration requests may be transmitted for one registration procedure. In this manner, one procedure or one type of processing within the procedure may be divided and performed a plurality of times. The same applies to procedures which will be described later.

User information is information regarding the user of the communication device 110. For example, a user ID, an account name, a user name, user contact information, a call sign, and the like can be assumed. The user ID and the account name may be uniquely generated by the user of communication device 110 or may be issued in advance by communication control device 130. It is desirable to use the call sign issued by the NRA.

The user information can be used, for example, for interference resolution. As a specific example, there may be a case where the communication control device 130 determines suspension of using a frequency being used by the communication device 110 and gives an instruction based on determination of suspension of use in a frequency use signaling procedure which will be described in <2.5> below, but a frequency use signaling request for the frequency continues to be signaled. In such a case, the communication control device 130 can suspect a problem in the communication device 110 and contact the user contact information included in the user information for request for checking the behavior of the communication device 110. The present disclosure is not limited to this example, and if it is determined that the communication device 110 is performing an operation contrary to communication control performed by the communication control device 130, the communication control device 130 can contact using the user information.

Unique information is information that can identify the communication device 110, product information of the communication device 110, information regarding hardware or software of the communication device 110, and the like.

The information that can identify the communication device 110 can include, for example, a manufacture number (serial number) of the communication device 110, the ID of the communication device 110, and the like. The ID of the communication device 110 may be uniquely given by the user of the communication device 110, for example.

The product information of the communication device 110 can include, for example, a certification ID, a product model number, information on the manufacturer, and the like. Certification IDs are IDs granted by a certification authority in each country or region, such as FCC IDs in the United States, CE numbers in Europe, and certifications of conformity with technical regulations in Japan (technical conformity). IDs issued by industry associations on the basis of their own certification programs may also be regarded as certification IDs.

The unique information represented by such information can be used, for example, for an allowlist or a denylist. For example, if any information regarding the communication device 110 in operation is included in the denylist, the communication control device 130 can give an instruction to suspend use of the frequency for the communication device 110 in the frequency use signaling procedure described in <2.5> below. Furthermore, the communication control device 130 can perform an operation such that suspension of use is not canceled until the communication device 110 is removed from the denylist. Further, for example, the communication control device 130 can reject registration of a communication device 110 included in the denylist. Further, for example, the communication control device 130 can also perform an operation of not considering a communication device 110 corresponding to information included in the denylist in interference calculation of the present disclosure or considering only a communication device 110 corresponding to information included in the allowlist in interference calculation.

In the present disclosure, FCC IDs may be handled as information regarding a transmission power. For example, in an equipment authorization system (EAS) database, which is a type of regulatory database, it is possible to obtain information on a device that has already been certified, and an application programming interface (API) thereof is also open to the public. For example, certified maximum EIRP information and the like can be included in the corresponding information together with an FCC ID. Since such power information is associated with an FCC ID, the FCC ID can be handled as transmission power information. Similarly, FCC IDs may be handled as equivalent to any other information included in the EAS. Further, if there is information associated with a certification ID, not limited to FCC IDs, the certification ID may be handled as equivalent to that information.

The information on the hardware of the communication device 110 can include, for example, transmission power class information. For example, U.S. Title 47 C.F.R (Code of Federal Regulations) Part 96 defines two types of classes, Category A and Category B, for the transmission power class information, and information on hardware of a communication device 110 that complies with the regulations can include information on which of the two classes includes it. Further, in TS36.104 and TS38.104 of 3rd Generation Partnership Project (3GPP), several classes of eNodeB and gNodeB are defined, and these regulations can also be used.

The transmit power class information can be used, for example, for interference calculation. Interference calculation can be performed using a maximum transmission power defined for each class as the transmission power of the communication device 110.

The information on the software of the communication device 110 can include, for example, version information, a build number, and the like regarding an execution program that describes processing required for interaction with the communication control device 130. In addition, version information, a build number, and the like of software for operating as the communication device 110 may also be included.

The location information is typically information that can identify the location of the communication device 110. For example, it is coordinate information obtained by a positioning function represented by a global positioning system (GPS), Beidou, a quasi-zenith satellite system (QZSS), Galileo, or an assisted global positioning system (A-GPS). Typically, information on a latitude, a longitude, ground height/above sea level, an altitude, and positioning error may be included. Alternatively, for example, it may be location information registered in an information management device managed by the National Regulatory Authority (NRA) or its entrusted agency. Alternatively, for example, it may be coordinates of X-, Y-, and Z-axes with a specific geographical position as the origin. Further, in addition to such coordinate information, an identifier indicating whether the communication device 110 is present outdoors or indoors can be given.

The location information may also include location uncertainty. For example, as the location uncertainty, both or either of horizontal and vertical planes can be provided. The location uncertainty can be used as a correction value, for example, at the time of calculating a distance to an arbitrary point. Further, for example, the location uncertainty can also be used as area information where the communication device 110 is likely to be located. In this case, it is used for processing such as identifying frequency information that can be used within the area indicated by the location uncertainty.

Further, the location information may be information indicating the area where the communication device 110 is located. For example, information indicating an area determined by the government, such as a postal code and an address may be used. Further, for example, an area may be indicated by a set of three or more geographic coordinates. Information indicating such an area may be provided along with coordinate information.

In addition, when the communication device 110 is located indoors, the location information may also include information indicating the floor of the building where the communication device 110 is located. For example, the location information can include identifiers indicating the number of floors, ground, and underground. Further, the location information can include information indicating more closed indoor spaces, such as room numbers and room names in the building.

Typically, it is desirable that the positioning function be provided in the communication device 110. However, there may be cases where the performance of the positioning function does not meet a required accuracy. Further, even if the performance of the positioning function satisfies the required accuracy, it may not always be possible to acquire location information that satisfies the required accuracy depending on the installation location of the communication device 110. Therefore, the positioning function may be provided in a device other than the communication device 110, and the communication device 110 may acquire information regarding the location from the device. Although the device having the positioning function may be an available existing device, it may be provided by the installer of the communication device 110. In such a case, it is desirable that location information measured by the installer of the communication device 110 be written to the communication device 110.

The antenna information is typically information indicating the performance, configuration, and the like of antennas provided in the communication device 110. Typically, information such as an antenna installation height, a tilt angle (Downtilt), a horizontal azimuth, boresight, an antenna peak gain, and an antenna model may be included.

The antenna information can also include information regarding beams that can be formed. For example, information such as a beam width, a beam pattern, and analog or digital beamforming capability can be included.

Further, the antenna information can also include information on the performance and configuration of MIMO (Multiple Input Multiple Output) communication. For example, information such as the number of antenna elements and the maximum number of spatial streams (or the number of MIMO layers) can be included. In addition, codebook information to be used, weight matrix information, and the like can also be included. The weight matrix information includes a unitary matrix, a zero-forcing (ZF) matrix, a minimum mean square error (MMSE) matrix, and the like. These are obtained by singular value decomposition (SVD), Eigen value decomposition (EVD), block diagonalization (BD), and the like. Further, if the communication device 110 has a function such as maximum likelihood detection (MLD) that requires nonlinear computation, the antenna information may include information indicating the function.

Further, the antenna information may include zenith of direction (ZoD, Departure). The ZoD is a kind of radio wave arrival angle. The ZoD may not be signaled from the communication device 110 but may be estimated and signaled by another communication device 110 from radio waves radiated from the antenna of the communication device 110. In this case, the communication device 110 may be a device operating as a base station or an access point, a device performing D2D communication, a moving relay base station, or the like. The ZoD can be estimated by radio wave arrival direction estimation technology such as Multiple Signal Classification (MUSIC) or Estimation of Signal Propagation via Rotation Invariance Techniques (ESPRIT). Further, the ZoD can also be used by the communication control device 130 as measurement information.

The radio interface information is typically information indicating the radio interface technology of the communication device 110. For example, the radio interface information can include identifier information indicating technology used in GSM, CDMA2000, UMTS, E-UTRA, E-UTRA NB-IoT, 5G NR, 5G NR NB-IoT or further next generation cellular systems. Further, identifier information indicating LTE (Long Term Evolution)/5G-compliant derivative technologies such as MulteFire, LTE-U (Long Term Evolution-Unlicensed), and NR-U (NR-Unlicensed) can also be included. In addition, identifier information indicating standard technologies such as MANs (Metropolitan Area Networks) such as WiMAX and WiMAX2+, and IEEE 802.11 wireless LANs may also be included. It may be identifier information indicating XGP (Extended Global Platform) or sXGP (Shared XGP). Further, it may be identifier information of a communication technology for LPWA (Local Power, Wide Area). Further, identifier information indicating proprietary wireless technologies can also be included. Further, version numbers or release numbers of technical specifications defining these technologies can be included as radio interface information.

In addition, the radio interface information may also include frequency band information supported by the communication device 110. For example, the frequency band information can be represented by an upper limit frequency, a lower limit frequency, a center frequency, a bandwidth, a 3GPP operating band number, a combination of at least two thereof, or the like. Further, one or more pieces of frequency band information may be included in the radio interface information.

The frequency band information supported by the communication device 110 can further include information indicating capabilities of band extension techniques such as carrier aggregation (CA) and channel bonding. For example, band information that can be combined may be included. In addition, regarding carrier aggregation, information regarding a band desired to be used as a primary component carrier (PCC) or a secondary component carrier (SCC) may also be included. In addition, the number of component carriers (CC number) that can be simultaneously aggregated can also be included.

The frequency band information supported by the communication device 110 may further include information indicating a combination of frequency bands supported by dual connectivity and multi-connectivity. In addition, information on other communication devices 110 that cooperatively provide dual connectivity and multi-connectivity may also be provided. In subsequent procedures, the communication control device 130 may determine communication control disclosed in the present embodiment in consideration of other communication devices 110 that are in a cooperative relationship, and the like.

The frequency band information supported by the communication device 110 may also include information indicating radio wave use priority such as PAL and GAA.

In addition, the radio interface information can also include modulation scheme information supported by the communication device 110. For example, as a representative example, information indicating primary modulation schemes such as frequency shift keying (FSK), n-value phase shift keying (PSK) (where n is a multiplier of 2, such as 2, 4, or 8), n-value quadrature amplitude modulation (QAM) (where n is a multiplier of 4, such as 4, 16, 64, 256, or 1024). It can also include information indicating secondary modulation schemes such as orthogonal frequency division multiplexing (OFDM), scalable OFDM, DFT spread OFDM (DFT-s-OFDM), generalized frequency division multiplexing (GFDM), and filter bank multi-carrier (FBMC).

In addition, the radio interface information can also include information on error correction code. For example, it can include capabilities such as turbo code, low density parity check (LDPC) code, Polar code, and erasure correction code, and coding rate information to be applied.

Information on modulation scheme information and error correction code can also be represented by modulation and coding scheme (MCS) indexes as another aspect.

The radio interface information can also include information indicating a function specific to each wireless technical specification supported by the communication device 110. For example, as a representative example, transmission mode (TM) information defined in LTE is conceivable. In addition, those having two or more modes for a specific function can be included in the radio interface information like TM information. Further, in technical specifications, if the communication device 110 supports a function that is not essential to the specifications even if two or more modes do not exist, information indicating the supported function can also be included.

In addition, the radio interface information can also include radio access technology (RAT) information supported by the communication device 110. For example, information indicating time division multiple access (TDMA), frequency division multiple access (FDMA), orthogonal frequency division multiple access (OFDMA), power division multiple access (PDMA), code division multiple access (CDMA), sparse code multiple access (SCMA), interleave division multiple access (IDMA), spatial division multiple access (SDMA), carrier sense multiple access/collision avoidance (CSMA/CA), carrier sense multiple access/collision detection (CSMA/CD), and the like can be included. TDMA, FDMA, and OFDMA are classified as orthogonal multiple access (OMA). PDMA, CDMA, SCMA, IDMA, and SDMA are classified as non-orthogonal multiple access (NOMA). A representative example of PDMA is a method realized by combining superposition coding (SPC) and successive Interference canceller (SIC). CSMA/CA and CSMA/CD are classified as opportunistic access.

If the radio interface information includes information indicating an opportunistic access method, it may further include information indicating details of the access method. As a specific example, information indicating whether it is Frame Based Equipment (FBE) or Load Based Equipment (LBE) defined in EN 301 598 of ETSI may be included.

When the radio interface information indicates LBE, it may further include LBE-specific information such as a priority class.

Further, the radio interface information can include information on duplex modes supported by the communication device 110. As a representative example, information regarding schemes such as frequency division duplex (FDD), time division duplex (TDD), and full duplex (FD) can be included.

When TDD is included as radio interface information, TDD frame structure information used or supported by the communication device 110 can be added. Further, information regarding duplex modes may be included for each frequency band indicated by frequency band information.

When FD is included as radio interface information, information on an interference power detection level may be included.

Further, the radio interface information can also include information on a transmit diversity technique supported by the communication device 110. For example, space time coding (STC) may be included.

In addition, the radio interface information can also include guard band information. For example, information on a predetermined guard band size can be included in a radio interface. Alternatively, for example, information on a guard band size desired by the communication device 110 may be included.

Regardless of the above aspect, the radio interface information may be provided for each frequency band.

The legal information typically information on regulations with which the communication device 110 must comply, which is defined by a radio wave administrative agency of each country or region, or equivalent organizations, certification information acquired by the communication device 110, and the like. The information on regulations can typically include, for example, upper limit information on out-of-band radiation, information on blocking properties of receivers, and the like. The certification information can typically include, for example, type approval information, regulatory information that serves as a standard for obtaining certification, and the like. The type approval information corresponds U.S. FCC IDs, Japanese technical standards conformity certification, and the like, for example. The regulatory information corresponds to U.S. FCC regulation numbers, European ETSI Harmonized Standard numbers, and the like, for example.

Among the legal information, information relating to numerical values may be replaced by information specified in radio interface technology specifications. The radio interface technology specifications correspond to 3GPP TS 36.104 and TS 38.104, and the like, for example. An adjacent channel leakage ratio (ACLR) is specified for these. Instead of the upper limit information on out-of-band radiation, the ACLR specified in the specifications may be used to derive and use an upper limit value of out-of-band radiation. Further, ACLR itself may be used as necessary. Adjacent channel selectivity (ACS) may also be used instead of blocking properties. Further, these may be used together, or an adjacent channel interference ratio (ACIR) may be used. In general, the ACIR has the following relationship with the ACLR and ACS.

$$\begin{matrix}[ Math . 1 ] & \\ ACIR = {( \frac{1}{ACs} + 1 ACLR )}^{- 1} & ( 1 )\end{matrix}$$

Although formula (1) uses a true value expression, it may be represented by a logarithmic expression.

The installer information can include information that can identify the person (installer) who installed the communication device 110, unique information associated with the installer, and the like. Typically, installer information can include information on an individual who is responsible for the location information of the communication device 110, which is called a certified professional installer (CPI) defined in NPL 2. CPI discloses a certified professional installer registration ID (CPIR-ID) and a CPI name. In addition, as unique information associated with to CPI, for example, contact address (a mailing address or contact address), an e-mail address, a telephone number, a public key identifier (PKI), and the like are disclosed. The installer information is not limited thereto and other information on the installer may be included in the installer information as needed.

The group information can include information on a communication device group to which the communication device 110 belongs. Specifically, for example, information regarding groups of the same or equivalent types as those disclosed in WINNF-SSC-0010 may be included. Further, if a communication carrier manages the communication devices 110 in units of groups according to its own operation policy, for example, information regarding the group can be included in the group information.

The information listed so far may be inferred by the communication control device 130 from other information provided by the communication device 110 instead of being provided from the communication device 110 to the communication control device 130. Specifically, for example, guard band information can be inferred from radio interface information. If the radio interface used by the communication device 110 is E-UTRA or 5G NR, it can be inferred on the basis of E-UTRA transmission bandwidth specifications described in 3GPP TS36.104, 5G NR transmission bandwidth specifications described in 3GPP TS38.104, and tables described in TS38.104 shown below.

TABLE 1
Table 5.6-1 Transmission bandwidth configuration
NRB in E-UTRA channel bandwidths (quoted
from Table 5.6-1 of TS36.104 of 3GPP)

| | Channel bandwidth BW_{Channel} [MHz] | | | | | |
|---|---|---|---|---|---|---|
| | 1.4 | 3 | 5 | 10 | 15 | 20 |
| Transmission band | 6 | 15 | 25 | 50 | 75 | 100 |
| width configuration | | | | | | |
| N_{RB} | | | | | | |

TABLE 2
Table 5.3.3-1: Minimum guardband (kHz) (FR1) (quoted from Table 5.3.3-1 of TS38.104 of 3GPP)

| SCS | 5 | 10 | 15 | 20 | 25 | 30 | 40 | 50 | 60 | 70 | 80 | 90 | 100 |
|---|---|---|---|---|---|---|---|---|---|---|---|---|---|
| (kHz) | MHz | MHz | MHz | MHz | MHz | MHz | MHz | MHz | MHz | MHz | MHz | MHz | MHz |
| 15 | 242.5 | 312.5 | 382.5 | 452.5 | 522.5 | 592.5 | 552.5 | 692.5 | N.A | N.A | N.A | N.A | N.A |
| 30 | 505 | 665 | 645 | 805 | 785 | 945 | 905 | 1045 | 825 | 965 | 925 | 885 | 845 |
| 60 | N.A | 1010 | 990 | 1330 | 1310 | 1290 | 1610 | 1570 | 1530 | 1490 | 1450 | 1410 | 1370 |

TABLE 3
Table: 5.3.3-2: Minimum guardband (kHz) (FR2)
(quoted from Table 5.3.3-2 of TS38.104 of 3GPP)

| SCS (kHz) | 50 MHz | 100 MHz | 200 MHz | 400 MHz |
|---|---|---|---|---|
| 60 | 1210 | 2450 | 4930 | N.A |
| 120 | 1900 | 2420 | 4900 | 9860 |

TABLE 4
Table: 5.3.3-3: Minimum guardband (kHz) of SCS 240 kHz SS/PBCH
block (FR2) (quoted from Table 5.3.3-3 of TS38.104 of 3GPP)

| SCS (kHz) | 100 MHz | 200 MHz | 400 MHz |
|---|---|---|---|
| 240 | 3800 | 7720 | 15560 |

In other words, the communication control device 130 may acquire the information listed so far, and the communication device 110 does not necessarily need to provide the information to the communication control device 130. Further, an intermediate device 130B (e.g., network manager) that bundles a plurality of communication devices 110 does not need to provide the information to the communication control device 130A. Provision of information by the communication device 110 or the intermediate device 130B to the communication control device 130 or 130A is merely one means of providing information in the present embodiment. The information listed so far means that the communication control device 130 means information that can be necessary for normal completion of the present procedure, and means of providing the information does not matter. For example, such an approach is called multi-step registration and allowed in WINNF-TS-0061.

In addition, it goes without saying that the information listed so far can be selectively applied according to a legal system and technical specifications of a region.

### <2.1.1.1 Supplement to Required Parameters>

In the registration procedure, it is assumed that device parameters regarding not only the communication device 110 but also the terminal 120 are required to be registered in the communication control device 130. In such a case, the term “communication device” in the description in <2.1.1> may be replaced with the term “terminal” or a similar term. Further, parameters specific to “terminal” which are not mentioned in <2.1.1> may be handled as required parameters in the registration procedure. For example, a user equipment (UE) category defined by 3GPP, and the like are conceivable.

### <2.1.2 Details of Registration Processing>

As described above, the communication device 110 representing a wireless system that intends to use a frequency band generates a registration request including device parameters and signals the registration request to the communication control device 130.

Here, if the device parameters include installer information, the communication device 110 may perform falsification prevention processing on the registration request using the installer information. Further, encryption processing may be performed on some of all information included in the registration request. Specifically, for example, a unique public key may be shared in advance between the communication device 110 and the communication control device 130, and the communication device 110 may encrypt information using uses a private key corresponding to the public key. As an encryption target, for example, information sensitive to crime prevention, such as location information, is conceivable.

The IDs and location information of communication devices 110 may be open to the public and the communication control device 130 may have the IDs and location information of main communication devices 110 within the coverage thereof in advance. In such a case, since the communication control device 130 can obtain location information from the ID of a communication device 110 that has transmitted a registration request, the location information need not be included in the registration request. Further, it is also conceivable that the communication control device 130 returns necessary device parameters to the communication device 110 that has transmitted the registration request, and in response, the communication device 110 transmits a registration request including device parameters necessary for registration. In this manner, information included in the registration request may vary according to circumstances.

After receiving the registration request, the communication control device 130 performs registration processing of the communication device 110 and returns a registration response according to a processing result. If there is no shortage of information necessary for registration and no abnormality, the communication control device 130 records the information in an internal or external storage device and signals normal completion. Otherwise, it signals registration failure. When registration is normally completed, the communication control device 130 may assign an ID to each communication device 110 and signal the ID information at the time of response. In case of registration failure, the communication device 110 may re-signal a modified registration request. Further, the communication device 110 may change the registration request and attempt the registration procedure until normal completion.

The registration procedure may be executed even after successful completion of registration. Specifically, the registration procedure may be re-executed if location information changes beyond a predetermined standard, for example, due to movement, accuracy improvement, or the like. The predetermined standard is typically set by national or regional legal systems. For example, in 47 C.F.R Part 15 of the United States, Mode II personal/portable white space devices, that is, devices that use vacant frequencies, must be re-registered if their locations change by 100 meters or more.

### <2.2 Available Spectrum Query Procedure>

An available spectrum query procedure is a procedure in which a wireless system that intends to use a frequency band inquires of the communication control device 130 for information on available frequencies. It is not always necessary to carry out the available spectrum query procedure. Further, a communication device 110 that makes a query on behalf of the wireless system that intends to use a frequency band may be the same as or different from a communication device 110 that has generated a registration request. Typically, the procedure is started by the communication device 110, which makes a query, signaling a query request including information that can identify the communication device 110 to the communication control device 130.

Here, available frequency information is typically information indicating a frequency that the communication device 110 can safely use for secondary use without fatal interference with the primary system.

The available frequency information is determined, for example, on the basis of a secondary use prohibited area called an exclusion zone. Specifically, for example, if the communication device 110 is installed in the secondary use prohibited area provided for the purpose of protecting the primary system that uses a frequency channel F1, the frequency channel F1 is not signaled as an available channel to the communication device 110.

The available frequency information can also be determined, for example, by a degree of interference with the primary system. Specifically, for example, a frequency channel may not be signaled as an available channel if it is determined that it will cause fatal interference to the primary system even if it is outside the secondary use prohibited area. An example of a specific calculation method is described in <2.2.2> below.

Further, as described above, a frequency channel that is not signaled as an available channel can be present according to conditions other than primary system protection requirements. Specifically, for example, in order to avoid interference that may occur between communication devices 110 in advance, a frequency channel being used by another communication device 110 present in the vicinity of the corresponding communication device 110 may not be signaled as an available channel. In this manner, available frequency information set in consideration of interference with other communication devices 110 may be set as, for example, a “recommended spectrum” and provided along with the available frequency information. That is, it is desirable that the “recommended spectrum” be a subset of the available frequency information.

Even if the primary system is affected, the same frequency as that of the primary system or a neighboring communication device 110 may be signaled as an available channel if the influence can be avoided by reducing a transmission power. In such a case, maximum allowable transmission power information is typically included in the available frequency information. The maximum allowable transmission power is typically represented as EIRP. It is not always necessary to be limited to this, and it may be provided as a combination of conducted power and an antenna gain, for example. Furthermore, for the antenna gain, an allowable peak gain may be set for each spatial direction.

### <2.2.1 Details of Required Parameters>

Information that can identify a wireless system that intends to use a frequency band can be assumed to be, for example, unique information registered at the time of the registration procedure, the above-mentioned ID information, and the like.

In addition, a query request can also include query requirement information. The query requirement information can include, for example, information indicating a frequency band whose availability is desired to be known. Further, for example, transmission power information can also be included. A communication device 110 that makes a query can have transmission power information, for example, if it wants to know only frequency information that is likely to use a desired transmission power. The query requirement information does not necessarily need to be included in the query request.

Information indicating a frequency band can also include information indicating the format of available frequency information. The IEEE 802.11 standards define a channel number for each band. For example, it may include a flag requesting whether or not to use a channel defined by such radio interface technical specifications. Alternatively, a flag requesting whether or not to use a unit frequency range rather than a defined channel may be included. If a unit frequency is 1 MHZ, available frequency information is requested for each frequency range of 1 MHz. If this flag is used, desired unit frequency information may be enclosed in the flag.

Further, the query request can also include a measurement report. The measurement report includes results of measurements performed by the communication device 110 and/or the terminal 120. Some or all of the measurement results may be represented by raw data or processed data. For example, standardized metrics represented by reference signal received power (RSRP), a reference signal strength indicator (RSSI), and reference signal received quality (RSRQ) can be used for measurement.

### <2.2.2 Details of Available Frequency Evaluation Processing>

After receiving a query request, available frequencies are evaluated on the basis of query requirement information. For example, as described above, it is possible to evaluate available frequencies in consideration of the primary system, a secondary use prohibited area thereof, and presence of neighboring communication devices 110.

The communication control device may derive the secondary use prohibited area. For example, if a maximum transmission power PMaxTx (dBm) and a minimum transmission power PMinTx (dBm) are defined, it is possible to determine the secondary use prohibited area by calculating a range of the distance between the primary system and a secondary system using the following formula.

$$[ Math . 2 ]$$

$${{PL}^{- 1} ( {P}_{MaxTx ( dBm )} - {I}_{Th ( dBm )} )}_{( dB )} \leq d < {{PL}^{- 1} ( {P}_{MinTx ( dBm )} - {I}_{Th ( dBm )} )}_{( dB )}$$

I_{Th(dBm)} is an allowable interference power (limit value of the allowable interference power), d is the distance between a predetermined reference point and the communication device 110, and PL( )_{(dB)} is a propagation loss function. Accordingly, frequency availability can be determined according to a positional relationship between the primary system and the communication device 110. Further, if transmission power information or power range information that the communication device 110 wants to use is supplied through a request, it is possible to determine frequency availability by calculating PL⁻¹(P_{Tx(dBm)}−I_{Th(dBm)}) and comparing it with the aforementioned range formula.

Maximum allowable transmission power information may be derived. Typically, the maximum allowable transmission power information is calculated using allowable interference power information in the primary system or a protection zone thereof, location information of a reference point for calculating an interference power level suffered by the primary system, registration information of the communication device 110, and a propagation loss estimation model. Specifically, as an example, it is calculated by the following formula.

$$\begin{matrix}[ Math . 3 ] & \\ {P}_{MaxTx ( dBm )} = {I}_{Th ( dBm )} + {PL ( d )}_{( dB )} & ( 2 )\end{matrix}$$

In formula (2), an antenna gain in a transceiver is not included, but the antenna gain in the transceiver may be included according to a maximum allowable transmission power expression method (EIRP, conducted power, and the like) and reception power reference points (antenna input point, antenna output point, and the like). Further, a safety margin or the like for compensating for variations due to fading may also be included. Further, a feeder loss may also be considered as necessary. In addition, it is possible to perform similar calculations for neighboring channels by additionally taking an adjacent channel leakage ratio (ACRL) and a maximum value of out-of-band radiation into account.

Further, formula (2) is written on the basis of the assumption that a single communication device 110 is an interference source (single-station interference). For example, if aggregated interference from a plurality of communication devices 110 must be considered at the same time, a correction value may be added. Specifically, for example, a correction value can be determined on the basis of three types (Fixed/Predetermined, Flexible, and Flexible Minimized) of interference margin allocation methods disclosed in NPL 3 (ECC Report 186).

It is not always possible to directly use allowable interference power information itself, as in formula (2). For example, if a required signal-power-to-interference-power ratio (SIR), a signal-to-interference-plus-noise ratio (SINR), and the like of the primary system are available, they may be converted into an allowable interference power and used. Such conversion processing is not limited to this processing and may also be applied to processing of other procedures.

Although formula (2) is expressed using logarithms, it may be converted to antilogarithms for practical use. In addition, all logarithmic parameters described in the present disclosure may be appropriately converted to antilogarithms and used.

Further, if the above-described transmission power information is included in query requirement information, it is possible to evaluate available frequencies by a method other than the above-described method. Specifically, for example, when it is assumed that a desired transmission power indicated by transmission power information is used, if an estimated amount of interference is less than an allowable interference power in the primary system or the protection zone thereof, it is determined that the corresponding frequency channel is available and signaled to the communication device 110.

Further, for example, if an area or a space in which the communication device 110 can use a frequency band, like the area of a radio environment map (REM), is predetermined, available frequency information may be simply derived on the basis of only coordinates (X-axis, Y-axis, and Z-axis coordinates or latitude, longitude, ground height of the communication device 110) included in the location information of the communication device 110. Further, for example, if a lookup table in which the coordinates of the location of the communication device 110 are associated with available frequency information is prepared, the available frequency information may also be derived on the basis of only the location information of the communication device 110. In this manner, there are various methods of determining available frequencies, which are not limited to the examples of the present disclosure.

In addition, when the communication control device 130 acquires information regarding capabilities of band extension techniques such as carrier aggregation (CA) and channel bonding as frequency band information supported by the communication device 110, the communication control device 130 may include these available combinations, recommended combinations, and the like in the available frequency information.

Further, when the communication control device 130 acquires information regarding a combination of frequency bands supported by dual connectivity and multi-connectivity as frequency band information supported by the communication device 110, the communication control device 130 may include, in the available frequency information, information such as available frequencies and recommended frequencies for dual connectivity and multi-connectivity.

Further, when available frequency information for the band extension techniques as above is provided, if there is an imbalance in the maximum allowable transmission power among a plurality of frequency channels, a maximum allowable transmission power for each frequency channel may be adjusted and then the available frequency information may be provided. For example, from the viewpoint of primary system protection, the maximum allowable transmission power of each frequency channel may be aligned with a maximum allowable transmission power of a frequency channel having a low maximum allowable power spectral density (PSD).

Evaluation of available frequencies does not necessarily need to be performed after a query request is received. For example, the communication control device 130 may proactively perform the evaluation without a query request after normal completion of the registration procedure described above. In such a case, the REM or lookup table shown in an example above, or an information table similar thereto may be created.

In addition, radio wave use priority such as PAL and GAA may also be evaluated. For example, if registered device parameters or query requirements include information on the priority of radio wave use, it may be possible to determine whether or not frequency use is possible on the basis of the priority and signal it. Further, as disclosed in NPL 2, for example, if information (referred to as a cluster list in NPL 2) on the communication device 110 that performs high-priority use (for example, PAL) has been registered by a user in advance in the communication control device 130, evaluation may be performed on the basis of this information.

After completion of evaluation of available frequencies, the communication control device 130 signals the evaluation result to the communication device 110.

The communication device 110 may select desired communication parameters using the evaluation result received from the communication control device 130. If a spectrum grant procedure, which will be described later, is not adopted, the communication device 110 may start radio wave transmission using the selected desired communication parameters as communication parameters.

### <2.3 Spectrum Grant Procedure>

The spectrum grant procedure is a procedure for a wireless system that intends to use a frequency band to receive a secondary frequency use grant from the communication control device 130. A communication device 110 that performs the spectrum grant procedure on behalf of the wireless system may be the same as or different from the communication device 110 that has performed the procedures so far. Typically, the procedure is started by the communication device 110 signaling a spectrum grant request including information that can identify the communication device 110 to the communication control device 130. As described above, the available spectrum query procedure is not essential. Therefore, the spectrum grant procedure may be performed after the available spectrum query procedure or may be performed after the registration procedure.

In the present embodiment, it is assumed that at least the following two types of spectrum grant request methods can be used.
Designation method
Flexible method

The designation method is a request method in which the communication device 110 designates desired communication parameters and requests that the communication control device 130 grant operation based on the desired communication parameters. Desired communication parameters include, but are not limited to, frequency channels desired to be used, a maximum transmission power, and the like. For example, radio interface technology-specific parameters (modulation scheme, duplex mode, and the like) may be designated. In addition, information indicating radio wave use priority such as PAL and GAA may be included.

The flexible method is a request method in which the communication device 110 designates only requirements related to communication parameters and requests that the communication control device 130 designate communication parameters that allow secondary use while satisfying requirements. Requirements related to communication parameters include, but are not limited to, a bandwidth, a desired maximum transmission power, a desired minimum transmission power, and the like, for example. For example, radio interface technology-specific parameters (modulation scheme, duplex mode, and the like) may be designated. Specifically, for example, one or more TDD frame structures may be selected in advance and signaled.

Like query request, the spectrum grant request may also include a measurement report in any of the designated method and the flexible method. The measurement report includes results of measurements performed by the communication device 110 and/or the terminal 120. Measurement may be represented by raw data or may be represented by processed data. For example, standardized metrics represented by reference signal received power (RSRP), a reference signal strength indicator (RSSI), and reference signal received quality (RSRQ) can be used for measurement.

Method information used by the communication device 110 may be registered in the communication control device 130 during the registration procedure described in <2.1>.

### <2.3.1 Details of Spectrum Grant Processing>

After receiving a spectrum grant request, the communication control device 130 performs spectrum grant processing on the basis of a spectrum grant request method. For example, it is possible to perform spectrum grant processing in consideration of the primary system, the secondary use prohibited area, presence of neighboring communication devices 110, and the like using the method described in <2.2>.

When the flexible method is used, maximum allowable transmission power information may be derived using the method described in <2.2.2>. Typically, the maximum allowable transmission power information is derived using allowable interference power information in the primary system or the protection zone thereof, location information of a reference point for calculating an interference power level suffered by the primary system, registration information of the communication device 110, and a propagation loss estimation model. Specifically, as an example, it is calculated by the above formula (2).

Further, as described above, formula (2) is written on the basis of the assumption that a single communication device 110 is an interference source. For example, if aggregated interference from a plurality of communication devices 110 must be considered at the same time, a correction value may be added. Specifically, for example, the correction value can be determined on the basis of three types (Fixed/Predetermined, Flexible, and Flexible Minimized) of methods disclosed in NPL 3 (ECC Report 186).

The communication control device 130 can use various propagation loss estimation models in the spectrum grant procedure, available frequency evaluation processing for an available spectrum query request, and the like. If a model is designated for each application, it is desirable to use the designated model. For example, in NPL 2 (WINNF-TS-0112), a propagation loss model such as extended Hata (eHATA) or an irregular terrain model (ITM) is adopted for each application. Of course, propagation loss models are not limited thereto.

There are also propagation loss estimation models that require information on radio wave propagation paths. Information on radio wave propagation paths includes, for example, information indicating line of sight (LOS and/or non-line of sight (NLOS), topographical information (undulation, above sea level, and the like), and environmental information (urban, suburban, rural, open sky, and the like). When using propagation loss estimation models, the communication control device 130 may estimate these pieces of information from registration information of the communication device 110 and information of the primary system, which have already been acquired. Alternatively, if there are parameters designated in advance, it is desirable to use these parameters.

If a propagation loss estimation model is not designated for a predetermined application, it may be properly used as necessary. For example, propagation loss estimation models can be properly used in such a manner that a model that calculates a small loss, such as a free space loss model, is used at the time of estimating an interference power to another communication device 110, whereas a model that calculates a large loss is used at the time of estimating the coverage of the communication device 110.

Further, if a designated propagation loss estimation model is used, as an example, it is possible to perform spectrum grant processing according to evaluation of an interference risk. Specifically, for example, when it is assumed that a desired transmission power indicated by transmission power information is used, if an estimated amount of interference is less than an allowable interference power in the primary system or the protection zone thereof, it is determined that the corresponding frequency channel is permitted to be used, and is signaled to the communication device 110.

In both the designated method and the flexible method, radio wave use priority such as PAL and GAA may be evaluated in the same manner as the query request. For example, if registered device parameters or query requirements include information on radio wave use priority, it may be determined whether frequency use is possible on the basis of the priority and signaled. Further, for example, if information on a communication device 110 that performs high-priority use (for example, PAL) has been registered by a user in advance in the communication control device 130, evaluation may be performed on the basis of this information. For example, in NPL 2 (WINNF-TS-0112), information on the communication device 110 is called a cluster list.

Further, in any of the above calculations, when using location information of a communication device, frequency availability may be determined by correcting location information and coverage using location uncertainty.

Spectrum grant processing does not necessarily need to be performed due to reception of a spectrum grant request. For example, the communication control device 130 may proactively perform spectrum grant processing without a spectrum grant request after normal completion of the registration procedure. Further, for example, spectrum grant processing may be performed at regular intervals. In such a case, the aforementioned REM, lookup table, or a similar information table may be created. Accordingly, permissible frequencies can be determined only by location information, and thus the communication control device 130 can rapidly return a response after receiving the spectrum grant request.

### <2.4 Spectrum Use Notification/Heartbeat>

Spectrum use notification is a procedure in which a wireless system using a frequency band notifies the communication control device 130 of frequency use on the basis of communication parameters permitted to be used in the spectrum grant procedure. A communication device 110 that performs spectrum use notification on behalf of the wireless system may be the same as or different from the communication device 110 that has performed the procedures so far. Typically, the communication device 110 notifies the communication control device 130 of a notification message including information that can identify the communication device 110.

It is desirable that spectrum use notification be performed periodically until the communication control device 130 refuses to use a frequency. In that case, spectrum use notification is also called a heartbeat.

After receiving spectrum use notification, the communication control device 130 may determine whether to start or continue frequency use (in other words, radio wave transmission at a permitted frequency). As a determination method, for example, confirmation of frequency use information of the primary system is conceivable. Specifically, it is possible to determine whether to grant or deny initiation or continuation of frequency use (radio wave transmission at the allowed frequency) on the basis of change in frequency use of the primary system, change in the frequency use state of the primary system whose radio wave use is not regular (for example, a US CBRS shipboard radar, or the like), and the like. If initiation or continuation is granted, the communication device 110 may start or continue frequency use (radio wave transmission at the allowed frequency).

After receiving spectrum use notification, the communication control device 130 may order the communication device 110 to reconfigure communication parameters. Typically, reconfiguration of the communication parameters can be instructed in response of the communication control device 130 to spectrum use notification. For example, information on recommended communication parameters (hereinafter, recommended communication parameter information) can be provided. It is desirable that the communication device 110 provided with the recommended communication parameter information use the recommended communication parameter information to perform the spectrum grant procedure described in <2.4> again.

### <2.5 Supplement to Various Procedures>

The above-described various procedures do not necessarily need to be implemented individually, as described below. For example, two different procedures may be realized by substituting a third procedure with the roles of the two different procedures. Specifically, for example, a registration request and an available spectrum query request may be signaled together. Further, for example, the spectrum grant procedure and spectrum use notification may be integrally performed. Of course, the present disclosure is not limited to these combinations, and three or more procedures may be integrally performed. Further, as described above, one procedure may be divided and performed a plurality of times.

In addition, the expression “acquire” or similar expressions in the present disclosure does not necessarily mean acquisition according to the procedures described in the present disclosure. For example, although it is described that the location information of the communication device 110 is used in the available frequency evaluation process, this means that it is not always necessary to use information acquired in the registration procedure and the location information may be used if the location information is included in the available spectrum query procedure request. In other words, the procedure for acquisition described in the present disclosure is an example, and acquisition by other procedures is also permitted within the scope of the present disclosure and within the scope of technical feasibility.

Further, the information described as being included in the response from the communication control device 130 to the communication device 110 may be actively signaled by the communication control device 130 by a push method if possible. As a specific example, available frequency information, recommended communication parameter information, radio wave transmission continuation denial notification, and the like may be signaled by a push method.

### <2.6 Procedures Regarding Terminal>

Description has focused on processing in the communication device 110A. However, depending on embodiments, not only the communication device 110A but also the terminal 120 and the communication device 110B may operate under the control of the communication control device 130. That is, a scenario in which communication parameters are determined by the communication control device 130 is assumed. Even in such a case, it is basically possible to use the procedures described in <2.1> to <2.4>. However, unlike the communication device 110A, the terminal 120 and the communication device 110B need to use frequencies managed by the communication control device 130 for the backhaul link and cannot arbitrarily transmit radio waves. Therefore, it is desirable to start backhaul communication for accessing the communication control device 130 for the first time since detection of radio waves or an authorization signal transmitted by the communication device 110A (a communication device 110 capable of providing a wireless communication service or a master communication device 110 in a master-secondary type).

Meanwhile, under the control of the communication control device 130, allowable communication parameters may be set for the terminal and the communication device 110B for the purpose of protecting the primary system. However, the communication control device 130 cannot ascertain location information of these devices in advance. Further, these devices are highly likely to have mobility. That is, the location information is dynamically updated. Depending on the legal system, re-registration with the communication control device 130 may be obligatory when the location information changes more than a certain amount.

In consideration of such various use forms and operation forms of the terminal 120 and the communication device 110, two types of communication parameters shown below are defined in the TVWS operation form (NPL 4) set by the Office of Communication (Ofcom).
Generic operational parameters
Specific operational parameters

Generic operational parameters are communication parameters defined in NPL 4 as “parameters that can be used by any slave WSD located within the coverage area of a predetermined master WSD (corresponding to the communication device 110)”. A feature is that it is calculated by a WSDB without using the location information of the slave WSD.

The generic operational parameters can be provided by unicast or broadcast from the communication device 110 that has been already granted by the communication control device 130 to transmit radio waves. For example, a broadcast signal represented by the contact verification signal (CVS) defined in Part 15 Subpart H of the FCC Rules of the United States can be used. Alternatively, it may be provided by a radio interface specific broadcast signal. Accordingly, the terminal 120 and the communication device 110B can handle the generic operational parameters as communication parameters used for radio wave transmission for the purpose of accessing the communication control device 130.

Specific operational parameters are communication parameters defined in NPL 4 as “parameters that can be used by a specific slave white space device (WSD)”. In other words, they are communication parameters calculated using device parameters of the slave WSD corresponding to the terminal 120. A feature is that it is calculated by a white space database (WSDB) using the location information of the slave WSD.

The CPE-CBSD handshake procedure defined in NPL 5 can be regarded as another form of a procedure for terminals. CPE-CBSD does not have a wired backhaul line and accesses the Internet via BTS-CBSD. Therefore, it is not possible to obtain a grant to transmit radio waves from an SAS for a CBRS band without special regulations and procedures. The CPE-CBSD handshake procedure allows the CPE-CBSD to transmit radio waves with the same maximum EIRP and minimum required duty cycle as those of a terminal (EUD) until it obtains a grant to transmit radio waves from the SAS. Accordingly, the communication device 110B can construct a line for obtaining a grant to transmit radio waves from the communication control device 130 by setting the transmission EIRP to the maximum EIRP of terminals and then performing wireless communication with the communication device 110A at the minimum required duty cycle. After obtaining the grant to transmit radio waves, it is possible to use up to the maximum EIRP specified for communication devices within the range of grant.

### <2.7 Procedures Generated Between Communication Control Devices>

### <2.7.1 Information Exchange>

The communication control device 130 can exchange management information with other communication control devices 130. It is desirable that at least the following information be exchanged.
Information regarding the communication device 110
Area information
Protection target system information

Information regarding the communication device 110 includes at least registration information and communication parameter information of the communication device 110 operating under the grant of the communication control device 130. Registration information of communication devices 110 that do not have granted communication parameters may also be included.

The registration information of the communication device 110 is typically device parameters of the communication device 110 registered in the communication control device 130 in the registration procedure described above. Not all registered information is necessarily exchanged. For example, information that may correspond to personal information need not be exchanged. Further, at the time of exchanging the registration information of the communication device 110, the registration information may be encrypted and exchanged, or the information may be exchanged after making the contents of the registration information ambiguous. For example, information converted into binary values or information signed using an electronic signature mechanism may be exchanged.

The communication parameter information of the communication device 110 is typically information regarding communication parameters currently used by the communication device 110. It is desirable that at least information indicating a frequency to be used and a transmission power be included. Other communication parameters may also be included.

The area information is typically information indicating a predetermined geographical area. This information can include area information of various attributes in various manners.

For example, like the PAL protection area (PPA) disclosed in NPL 2 (WINNF-TS-0112), the area information may include protection area information of the communication device 110 serving as a high-priority secondary system. The area information in this case can be represented, for example, by a set of three or more coordinates indicating geographic positions. Further, for example, if a plurality of communication control devices 130 can refer to a common external database, area information can be represented by a unique ID, and the actual geographic area can be referenced from the external database using the ID.

Further, for example, information indicating the coverage of the communication device 110 may be included. The area information in this case can also be represented, for example, by a set of three or more coordinates indicating geographical positions. Further, the coverage can be assumed to be a circle having the geographical location of the communication device 110 as a center and can be represented by information indicating the size of the radius, for example. Further, if a plurality of communication control devices 130 can refer to a common external database that records area information, for example, the information indicating the coverage can be represented by a unique ID, and the actual coverage can be referenced from the external database using the ID.

In addition, as another aspect, information regarding area divisions predetermined by administration or the like can also be included. Specifically, for example, it is possible to indicate a certain area by indicating an address. Further, for example, a license area can be similarly represented.

As further another aspect, area information does not necessarily need to represent a planar area and may represent a three-dimensional space. For example, it may be represented using a spatial coordinate system. Further, for example, information indicating a predetermined closed space, such as the number of floors of a building, a floor, a room number, and the like may be used.

Protection target system information is, for example, information of a wireless system handled as a protection target, such as the above-mentioned incumbent tier. Situations in which this information must be exchanged include, for example, situations requiring cross-border coordination. It is quite conceivable that neighboring countries or regions have different protection targets in the same band. In such a case, protection target system information can be exchanged between communication control devices 130 belonging to different countries or regions as needed.

As another aspect, protection target system information can include information on a secondary licensee and information on a wireless system operated by the secondary licensee. A secondary licensee is specifically a lessee of a license, and for example, it is assumed that a secondary licensee borrows a PAL from the holder and operates their own wireless system. If the communication control device 130 independently manages leases, it can exchange information on a secondary licensee and information on a wireless system operated by the secondary licensee with another communication control device for the purpose of protection.

Such information can be exchanged between communication control devices 130 regardless of the decision-making topology applied to the communication control devices 130.

In addition, such information can be exchanged by various methods. An example is shown below.
ID designation method
Period designation method
Area designation method
Dump method

The ID designation method is a method of acquiring information corresponding to an ID assigned in advance to identify information managed by the communication control device 130 using the ID. For example, it is assumed that a communication device 110 with ID: AAA is managed by a first communication control device 130. In this case, a second communication control device 130 issues an information acquisition request to the first communication control device 130 by designating ID: AAA. After receiving the request, the first communication control device 130 searches for information of ID: AAA and signals information on the communication device 110 with ID: AAA, for example, registration information and communication parameter information, and the like as a response.

The period designation method is a method in which information that satisfies predetermined conditions can be exchanged during a designated period.

The predetermined conditions may include, for example, whether or not information is updated. For example, when acquisition of information on the communication device 110 during a specific period has been designated through a request, registration information of a communication device 110 newly registered within the specific period can be signaled through a response. In addition, the registration information or communication parameter information of the communication device 110 having communication parameters that have been changed within the specific period can also be signaled through the response.

The predetermined conditions include, for example, whether or not information has been recorded by the communication control device 130. For example, when acquisition of information on the communication device 110 during a specific period has been designated through a request, registration information or communication parameter information recorded by the communication control device 130 during that period can be signaled through a response. When the information has been updated during that period, the latest information in that period can be signaled. Alternatively, an update history may be signaled for each piece of information.

In the area designation method, a specific area is designated and information on communication devices 110 belonging to the area is exchanged. For example, when acquisition of information on communication devices 110 in a specific area has been designated through a request, registration information or communication parameter information of communication devices 110 installed in the specific area can be signaled through a response.

The dump method is a method of providing all information recorded by the communication control device 130. It is desirable that at least information regarding the communication device 110 and area information be provided by the dump method.

Description of exchange of information between the communication control devices 130 so far is based on a pull method. That is, information corresponding to parameters designated through a request is returned as a response, and as an example, it can be realized by the HTTP GET method. However, it is not necessary to be limited to the pull method, and information may be actively provided to other communication control devices 130 by a push method. The push method can be realized by the HTTP POST method, for example.

### <2.7.2 Instruction/Request Procedure>

The communication control devices 130 may execute instructions or requests to each other. Specifically, as an example, reconfiguration of communication parameters of the communication device 110 is conceivable. For example, if it is determined that a first communication device 110 managed by a first communication control device 130 receives significant interference from a second communication device 110 managed by a second communication control device 130, the first communication control device 130 may request that the second communication control device 130 change the communication parameters of the second communication device 110.

As another example, reconfiguration of area information is conceivable. For example, if there is a fault in calculation of coverage information or protection area information regarding the second communication device 110 managed by the second communication control device 130, the first communication control device 130 may send a request for reconstruction of the area information to the second communication control device 130. In addition, reconstruction of the area information may be requested for various reasons.

### <2.8 Information Transmission Means>

Notification (signaling) between entities described so far can be realized through various media. As an example, E-UTRA or 5G NR will be described. Of course, implementations are not limited thereto.

### <2.8.2 Signaling Between Communication Control Device 130 and Communication Device 110>

Signaling from the communication device 110 to the communication control device 130 may be performed, for example, in an application layer. For example, it may be performed using the Hyper Text Transfer Protocol (HTTP). Signaling can be performed by describing required parameters in an HTTP message body according to a predetermined format. Furthermore, when the HTTP is used, signaling from the communication control device 130 to the communication device 110 is also performed according to an HTTP response mechanism.

### <2.8.3 Signaling Between Communication Device 110 and Terminal 120>

Signaling from the communication device 110 to the terminal 120 may be performed using, for example, at least any of radio resource control (RRC) signaling, system information (SI), and downlink control information (DCI). Further, as downlink physical channels, there are a physical downlink control channel (PDCCH), a physical downlink shared channel (PDSCH), a physical broadcast channel (PBCH), an NR-PDCCH, an NR-PDSCH, an NR-PBCH, and the like and the notification may be performed using at least any of these channels.

Signaling from the terminal 120 to the communication device 110 may be performed using, for example, radio resource control (RRC) signaling or uplink control information (UCI). Moreover, it may be performed using a physical uplink control channel (PUCCH), a physical uplink shared channel (PUSCH), and a physical random access channel (PRACH).

In addition to the physical layer signaling described above, signaling may be performed in a higher tier. For example, at the time of performing in the application layer, signaling may be performed by describing required parameters in the HTTP message body according to a predetermined format.

### <2.8.4 Signaling Between Terminals 120>

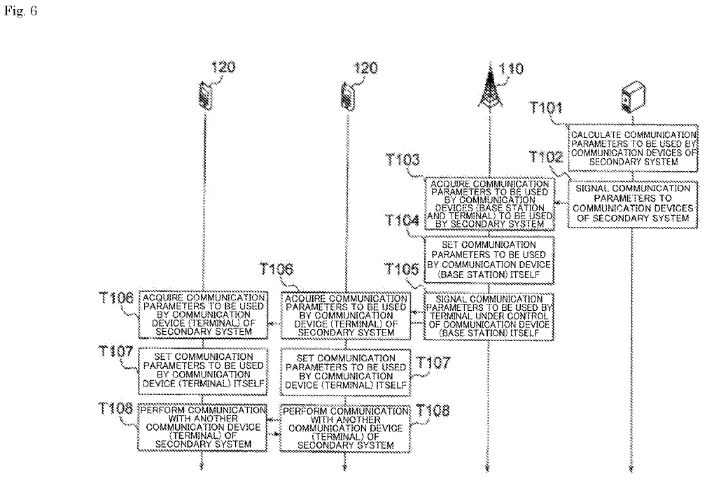

FIG. 6 shows an example of a signaling flow when D2D (Device-to-Device) or V2X (Vehicle-to-Everything), which is communication between terminals 120, is assumed as secondary system communication. D2D or V2X, which is communication between terminals 120, may be performed using a physical sidelink control channel (PSCCH), a physical sidelink shared channel (PSSCH), and a physical sidelink broadcast channel (PSBCH). The communication control device 130 calculates communication parameters to be used by the secondary system (T101) and signals them to the communication device 110 of the secondary system (T102). Values of the communication parameters may be determined and signaled, or conditions indicating ranges of the communication parameters may be determined and signaled. The communication device 110 acquires the communication parameters to be used by the secondary system (T103) and sets communication parameters to be used by the communication device 110 itself (T104). Then, the communication device 110 signals communication parameters to be used by a terminal 120 under the control of the communication device 110 to the terminal 120 (T105). Each terminal 120 under the control of the communication device 110 acquires communication parameters to be used by the terminal 120 (T106) and sets them (T107). Then, it performs communication with another terminal 120 of the secondary system (T108).

Communication parameters in the case of using a target frequency channel for frequency sharing in sidelink (direct communication between terminals 120) may be signaled in a form associated with a resource pool for the sidelink in the target frequency channel, acquired, or set. A resource pool is a radio resource for sidelink set by specific frequency resources or time resources. Frequency resources include, for example, resource blocks, component carriers, and the like. Time resources include, for example, radio frames, subframes, slots, mini-slots, and the like. At the time of setting a resource pool in a frequency channel for frequency sharing, the communication device 110 sets the resource pool in the terminal 120 on the basis of at least any of RRC signaling, system information, and downlink control information. Then, the communication device 110 also sets communication parameters to be applied in the resource pool and the sidelink in the terminal 120 on the basis of at least any of RRC signaling, system information, and downlink control information from the communication device 110 to the terminal 120. Signaling of setting of the resource pool and signaling of the communication parameters to be used in the sidelink may be performed simultaneously or separately.

### 3. Embodiments of Present Invention

As described above, at the time of complying with Title 47 C.F.R (Code of Federal Regulations) Part 96 in the United States, the communication control device 130 need not to manage the terminal 120, and thus the terminal 120 is not considered in various protection requirements and algorithms. Therefore, spectrum grants (which may be simply referred to as grants) of all communication devices (base stations or CBRS) 110, more specifically, radio waves of frequencies permitted by the grants, are considered as interference sources. Meanwhile, when a plurality of pairs of communication devices 110 are present and communication is performed for each pair, if grants of all communication devices 110 are considered as interference sources as in the prior art, all communication devices 110 are not necessarily radiate radio waves at the same time and thus excessive operational constraints are imposed. As a result, frequency band utilization efficiency may decrease.

In the present embodiment, a method of improving the frequency band utilization efficiency by devising allocation of interference margins when one or more pairs of communication devices 110 perform communication will be described.

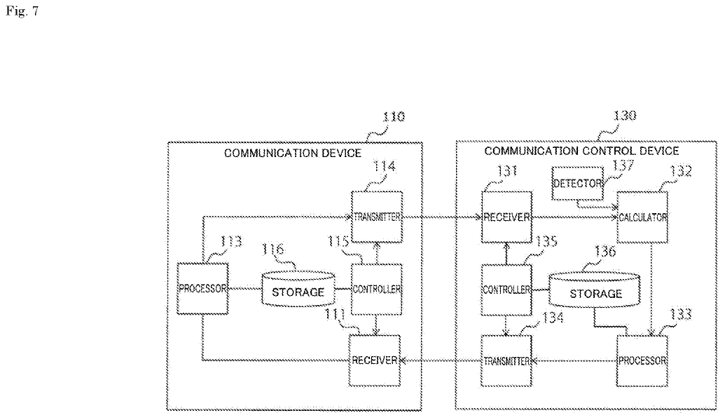

FIG. 7 is a block diagram of the communication network 100 according to an embodiment of the present disclosure.

The communication network 100 in FIG. 7 includes a plurality of communication devices 110 and communication control devices 130. Only blocks related to processing that is mainly related to the present embodiment are shown, and blocks related to other processing are omitted. Only one block diagram of the communication device 110 is shown. Although a case in which each communication device 110 is a CBSD and each communication control device 130 is an SAS is assumed below, the communication device 110 and the communication control device 130 are not limited to the CBSD and the SAS.

The communication control device 130 includes a receiver 131, a calculator 132, a processor 133, a transmitter 134, a controller 135, a storage 136, and a detector 137. The receiver 131 receives signals, data, or information from the communication device 110, other communication control devices, and the like in a wireless or wired manner. The transmitter 134 transmits signals, data, or information to the communication device 110, other communication control devices, and the like in a wireless or wired manner. An interface for communication with (reception from or transmission to) the communication device 110 and an interface for communication with (reception from or transmission to) other communication control devices may be different. The controller 135 controls the entire communication control device 130 by controlling each element in the communication control device 130.

The communication device 110 includes a receiver 111, a processor 113, a transmitter 114, a controller 115, and a storage 116. The receiver 111 receives signals, data, or information from other communication devices 110, the communication control device 130, terminal devices 120, and the like in a wireless or wired manner. The transmitter 114 transmits signals, data, or information to other communication devices 110, communication control devices 130, terminal devices 120, and the like in a wireless or wired manner. An interface for communication with (reception from or transmission to) other communication devices 110, an interface for communication with (reception from or transmission to) the communication control device 130, and an interface for communication with (reception from or transmission to) the terminal devices 120 may be different. The controller 115 controls the entire communication device 110 by controlling each element in the communication device 110.

The storage 136 of the communication control device 130 stores various types of information necessary for communication with the communication device 110 and other communication control devices. The storage 116 of the communication device 110 stores various types of information necessary for communication with other communication devices 110, communication with the communication control device 130, and communication with a terminal 120 to be provided with services.

Each processing block of the communication control device 130 and the communication device 110 is configured by a hardware circuit, software (program or the like), or both thereof. The storage 136 and the storage 116 are configured by an arbitrary storage device such as a memory device, a magnetic storage device, or an optical disc. The storage 136 and the storage 116 may be externally connected to the communication control device 130 and the communication device 110 in a wired or wireless manner, rather than being provided inside the communication control device 130 and the communication device 110. The transmitter 134 and the receiver 131 in the communication control device 130 and the transmitter 114 and the receiver 111 in the communication device 110 may include one or more network interfaces depending on the number or types of connectable networks. If the transmitter 134 and the receiver 131 in the communication control device 130 and the transmitter 114 and the receiver 111 in the communication device 110 perform wireless communication, each of the communication control device 130 and the communication device 110 may include at least one antenna.

The detector 137 of the communication control device 130 performs processing of detecting radio wave use by a primary system such as a radar system. A primary system is a system to be protected against radio wave interference from the communication device 110. The detector 137 may include an antenna for detection processing. Alternatively, the detector 137 may perform detection processing via the receiver 131 if the receiver 131 is provided with an antenna.

The calculator 132 of the communication control device 130 calculates a cumulative interference power (a first cumulative interference power), which is the sum of interference powers given to a protection target system by one or a plurality of communication device groups (CBSD groups), in time resource units. Here, the plurality of communication device groups perform communication on the basis of a plurality of time resources for communication, and the plurality of time resources are synchronized with each other. Each communication device group performs time division communication using, for example, a plurality of time resources. The number of members of one communication device group may be two, three or more. Basically, the following description will focus on a case in which the number of members is two, that is, there is a pair of communication devices (two communication devices). In the present embodiment, there are one or more such communication device pairs (e.g., CBSD pairs). Although a case in which there are a plurality of communication device groups is described in the present embodiment, a case in which there is only one communication device group is also possible.

More specifically, a plurality of communication device groups (communication device pairs) are time-synchronized with each other, and start and end timings of each time resource match. As an example, a time resource corresponds to each subframe in a frame including a plurality of subframes. The plurality of communication device groups may be distinguished as a first communication device group, a second communication device group, and so on. The plurality of time resources may be distinguished as a first time resource, a second time resource, and so on. Although the present embodiment describes a case in which time resources correspond to subframes, time resources may be referred to by other terms such as slots.

The processor 133 of the communication control device 130 determines an allowable amount of interference (interference margin) for each communication device of the plurality of communication device groups on the basis of the cumulative interference power of the plurality of communication device groups calculated for each subframe. The processor 133 determines a transmission power of each communication device on the basis of the interference margin of each communication device. Interference control is performed by the operation of determining the interference margin and transmission power in this manner.

The processor 133 of the communication control device 130 causes the communication device 110 to perform radio wave transmission based on the current grant by interference control, or corrects the grant to the communication device 110 (corrects at least one of the frequency band and transmission power) or re-issues the grant to cause the communication device 110 to perform radio wave transmission. The processor 133 may cause the communication device 110 to stop radio wave transmission.

The grant is issued by the communication control device 130 to allow the communication device 110 present in the vicinity of a protection target system to transmit radio waves. The processor 113 of the communication device 110 can perform radio wave transmission using a transmission power value indicated in the grant in a frequency band indicated in the grant by acquiring the grant in advance from the communication control device 130. The grant includes, for example, a grant ID, a value indicating the frequency band permitted to be used, a permitted transmission power value, and the like.

After acquiring the grant from the communication control device 130, the processor 113 of the communication device 110 determines not to perform radio wave transmission based on the acquired grant until next interference control (CPAS: Coordinated Periodic Activities among SASs) is executed. CPAS is performed once every 24 hours between the plurality of communication control devices 130 (SAS), and calculation and the like related to higher-tier protection are executed.

The processor 113 of the communication device 110 determines to continue radio wave transmission if radio wave transmission based on the current grant is permitted by interference control of the communication control device 130. The controller 115 controls the transmitter 114 and the receiver 111 according to determination of the processor 113. When the processor 113 of the communication device has corrected (corrected at least one of the frequency band and transmission power) or has re-acquired the grant according to a correction instruction from the communication control device 130 (SAS), the processor 113 determines not to perform radio wave transmission based on the corrected or reissued grant until next interference control (CPAS) is executed. The controller 115 controls the transmitter 114 and the receiver 111 according to determination of the processor 113. The communication device may be prohibited from radio wave transmission until the next interference control (CPAS) is executed.

<3.1.1 Case where Single CPE-CBSD Communicates with BTS-CBSD>

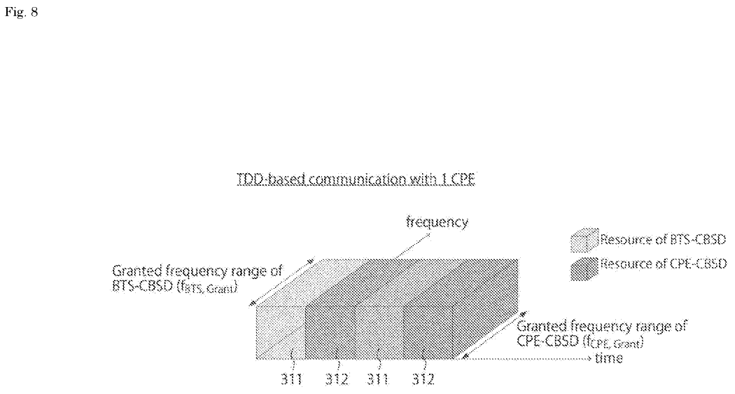

FIG. 8 is a diagram showing a relationship between a frequency and time at which CPE-CBSD communicates with BTS-CBSD when a pair of communication devices 110 (CBSD pair) is a pair of customer premises equipment (CPE)-CBSD and a base transceiver station (BTS)-CBSD. A CPE-CBSD is a facility installed on customer's premises in order to ensure network connection such as the Internet. A BTS-CBSD is a base station having a function of connecting a CPE-CBSD to a network such as the Internet. A pair of CPE-CBSD and BTS-CBSD corresponds to an example of one communication device group (communication device pair).

The CPE-CBSD can access networks such as the Internet via the BTS-CBSD without having a wired backhaul line. The terminal 120 wirelessly communicates with the BTS-CBSD via the CPE-CBSD to access the Internet. The CPE-CBSD and the BTS-CBSD wirelessly communicate with each other. The pair of CPE-CBSD and BTS-CBSD is present, for example, in the vicinity of the protection target system. The CPE CBSD may be defined such that it includes the terminal 120.

The BTS-CBSD uses a granted frequency range (f_{BTS, Grant}), which is a frequency band (frequency range) based on a grant approved by the SAS, and the CPE-CBSD uses a granted frequency range (f_{CPE, Grant}), which is a frequency band (frequency range) based on the grant approved by the SAS. The BTS CBSD communicates on time resources (e.g., subframes) 311 and the CPE CBSD communicates on time resources (e.g., subframes) 312 with the time resources 311 and 312 alternating. The time width of the time resources 311 is the same as that of the time resources 312. Further, the granted frequency range (f_{BTS, Grant}) is the same as the granted frequency range (f_{CPE, Grant}). The granted frequency range (f_{BTS, Grant}) and the granted frequency range (f_{CPE, Grant}) may overlap each other at least partially and interfere with each other.

The communication method between the CPE-CBSD and the BTS-CBSD is time division duplex (TDD). The BTS-CBSD and the CPE-CBSD do not radiate radio waves at the same time on the time axis. That is, radio waves in the same frequency band can be alternately radiated through the alternately repeated time resources 311 and 312.

The processor 133 of the communication control device (SAS) 130 acquires information on the pair of BTS-CBSD and CPE-CBSD that can be interference sources as CBSD group information and stores the acquired information in the storage 136. The CBSD group information includes, for example, CBSD pairing information and TDD configuration information. The TDD configuration information includes, for example, information on TDD synchronization. The TDD configuration information may be acquired when each CBSD is registered in the communication control device 130 as radio interface technical information.

The processor 133 of the communication control device 130 (SAS) determines the number of pairs of CPE-CBSD and BTS-CBSD, and if the number of pairs is one, considers only a CBSD that may cause stronger interference between the BTS-CBSD and the CPE-CBSD as an interference source. In this case, the processor 133 of the communication control device 130 may grant a CBSD, which may cause weaker interference, with parameters (designating transmission power and the like) based on the same interference margin as the CBSD, which may cause stronger interference. In order to identify the CBSD that may cause stronger interference between the CPE-CBSD and the BTS-CBSD, interference amounts of the CBSDs calculated on the basis of the transmission power of each CBSD and the distance from each CBSD to the protection target system may be compared. Alternatively, a method of simply determining the CBSD with a higher transmission power between the two CBSDs as the CBSD that may cause stronger interference is also possible.

When there are a plurality of CPE-CBSD and BTS-CBSD pairs, the processor 133 of the communication control device 130 (SAS) determines whether time resources are synchronized in all pairs. Synchronization of time resources means, for example, a state in which the same TDD frame configuration is used and TDD frames are time-synchronized. Asynchronization means a state other than synchronization (for example, a case where TDD frames are not aligned in each pair). It is assumed that a case in which time synchronization is unknown is handled as asynchronization.

Upon determining that each pair is not synchronized, the processor 133 identifies a CBSD that may cause stronger interference in each pair. Then, the processor 133 considers only the CBSD identified in each pair as an interference source and allocates interference margins. More specifically, the processor 133 determines an interference margin for each identified CBSD such that the cumulative interference power is equal to or less than an allowable amount of interference and determines transmission power on the basis of the interference margin. Then, a grant based on the determined transmit power is provided to each identified CBSD. A frequency band designated by the grant is assumed to be the same for respective identified CBSDs, or may be frequency bands in a relationship in which at least parts thereof overlap each other. In each pair, for a CBSD different from the aforementioned identified CBSD, the grant may be provided with parameters based on the same interference margin as the identified CBSD, or if the interference margin is equal to or less than the current interference margin, the current grant may be maintained. The processor 133 of the SAS can achieve interference protection for the protection target system (primary system) by performing such control (interference control).

When there are a plurality of CPE-CBSD and BTS-CBSD pairs, cases in which it is determined that time resources are synchronized in all pairs (a case in which TDD frames are aligned, and the like) will be described below.

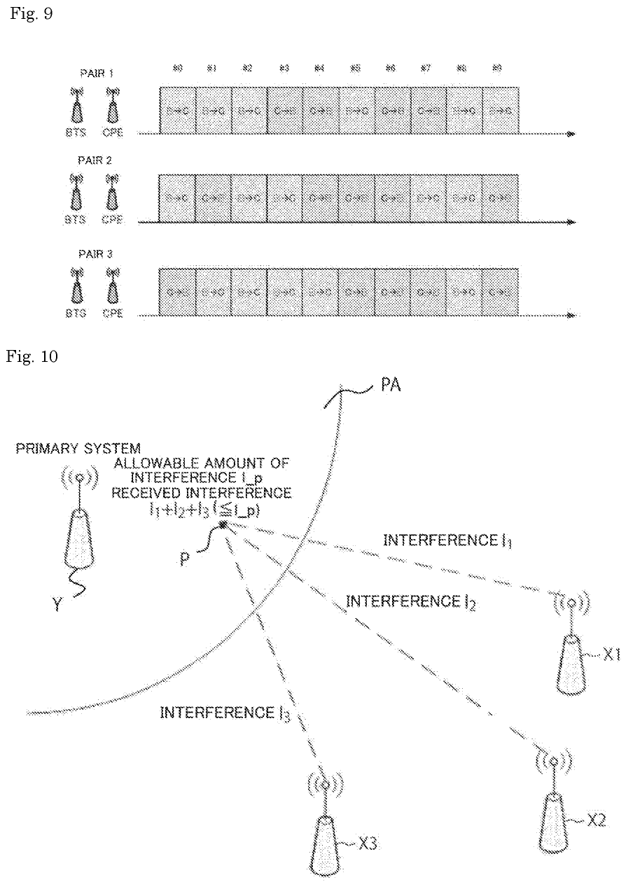

FIG. 9 is a diagram showing a communication relationship of each pair when there are a plurality of CPE-CBSD and BTS-CBSD pairs that can be interference sources and all pairs are synchronized.

There are a plurality of BTS-CBSD and CPE-CBSD pairs (pair 1, pair 2, and pair 3). Pair 1 to Pair 3 are synchronized. Synchronized pair groups correspond to first communication device groups that are synchronized with each other.

The processor 133 of the communication control device 130 compares configurations of TDD frames for the synchronized pairs 1 to 3. For comparison, for example, one frame in LTE, that is, 10 subframes may be compared. The calculator 132 of the communication control device 130 calculates a cumulative amount of interference by pairs 1 to 3 in each subframe (time resource) and identifies a subframe with the maximum calculated value. The communication control device 130 determines an interference margin of each sender (CBSD) using a sender of each pair in the identified subframe as an interference source (interference margin allocation processing), and determines an allowable transmission power for each sender on the basis of the interference margin of each sender. Meanwhile, interference control can be performed with the same concept even with interface technologies such as 5G NR.

As a specific example, it is assumed that a cumulative interference power (which may be referred to as a cumulative amount of interference) in subframe #4 in FIG. 9 is the maximum. At this time, interference control is performed with CPE-CBSD of pair 1, CPE-CBSD of pair 2, and BTS-CBSD of pair 3 as interference sources (senders). That is, an interference margin (allowable amount of interference) for each sender is determined by interference margin allocation processing (which will be described later), and a transmission power for each sender is determined such that the amount of interference becomes equal to or less than the interference margin. For each sender, it is determined whether or not radio wave transmission based on the current grant is possible.

If the transmission power of the current grant is equal to or less than the determined transmission power, the processor 133 of the communication control device 130 determines that it is unnecessary to correct or re-acquire the grant (radio wave transmission is possible). A CBSD for which it is determined that correction or re-acquisition of the grant is not necessary can start radio wave transmission. That is, the processor 133 of the communication control device 130 permits radio wave transmission based on the current grant. This corresponds to allocating an interference margin equivalent to single-station interference power (interference power based on the assumption that a single CBSD is an interference source) to the CBSD.

If the processor 133 of the communication control device 130 determines that the grant needs to be corrected, the processor 133 of the communication control device 130 transmits a grant correction parameter to the relevant CBSD. The correction parameter designates a transmission power based on the interference margin determined in interference margin allocation processing. The CBSD corrects the grant according to the correction parameter signaled from the communication control device 130. If the processor 133 of the communication control device 130 determines to reissue the grant, the processor 133 of the communication control device 130 reissues the grant designating the transmission power based on the interference margin determined in interference margin allocation processing as a parameter. Accordingly, the CBSD re-acquires the grant. Although it is assumed that the frequency band used by the CBSD does not change due to correction or re-acquisition of grant, a case in which it changes is not excluded. In this case, a parameter of the grant designates the frequency band after change.

When the grant of the sender in each pair is finally determined (the current grant is maintained or corrected, or the grant is re-acquired), the processor 133 of the communication control device 130 also determines the grant of the CBSD paired with the sender in each pair in the same way as the sender on the basis of the final grant. Accordingly, it is expected to further increase frequency availability. That is, the processor 133 determines whether or not radio wave transmission is possible with the current grant for the paired CBSD, and if it is determined that radio wave transmission is not possible, executes correction or reissuance of the parameters of the grant. As an example, the current transmission power (current grant) may be maintained if the transmission power of the paired CBSD is equal to or less than the transmission power determined on the basis of the same interference margin as the sender in each pair. If the transmission power of the paired CBSD exceeds the interference margin of the sender in each pair, the parameters of the grant are corrected or the grant is reissued such that the transmission power becomes equal to or less than the interference margin of the sender.

Although pairs 1 to 3 are synchronized in the example of FIG. 9, interference control (interference margin allocation processing) according to the above-described present embodiment may not be executed if there are other pairs that are not synchronized other than pairs 1 to 3. That is, interference control according to the present embodiment may be executed only when all pairs are synchronized. Alternatively, interference control according to the present embodiment may be executed only when a number of pairs equal to or greater than a reference value is present. For example, if the reference value is 3, interference control according to the present embodiment may be performed even if there are other pairs that are not synchronized as long as pairs 1 to 3 are synchronized. A method of further improving frequency utilization efficiency when there are other pairs that are not synchronized will be described later.

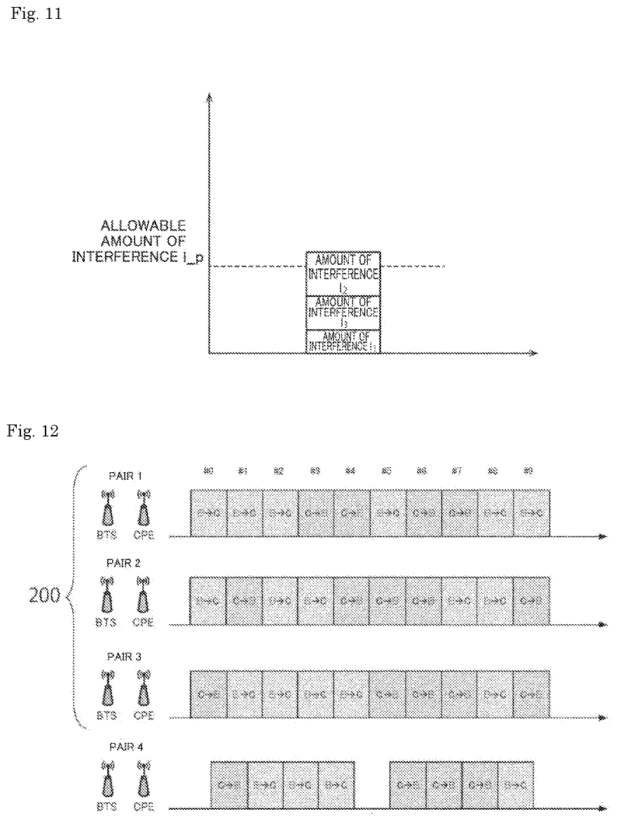

Interference margin allocation processing performed by the communication control device (SAS) 130 will be described using FIG. 10 and FIG. 11.

FIG. 10 is a schematic explanatory diagram of interference margin allocation processing. In FIG. 10, CBSDs (communication devices) X1, X2, and X3 are disposed. When the amounts of interference (interference power values) caused by CBSDs X1 to X3 at a point P within a protection target area (interference control target area) PA of a primary system Y are assumed to be I₁, I₂, and Is, the cumulative amount of interference at the point P is I₁+I₂+I₃. When it is assumed that an allowable amount of interference at the point P is I_p, the cumulative amount of interference I₁+I₂+I₃ needs to be equal to or less than the allowable amount of interference I_p. A CBSD interference margin is determined such that the cumulative amount of interference I₁+I₂+I₃ becomes equal to or less than the allowable amount of interference I_p, and a transmission power of each CBSD is determined. That is, an interference margin (that is, an interference margin per device) that is the allowable amount of interference for each CBSD is calculated by allocating the allowable amount of interference at the point P to a plurality of CBSDs (secondary systems).

FIG. 11 shows an example of determining an interference margin (allowable amount of interference) for each CBSD in interference margin allocation processing. The interference amounts I₁ to I₃ of CBSDs X1 to X3 are cumulatively added in ascending order, and if the allowable amount of interference I_p is exceeded during cumulative addition, radio wave transmission is permitted with the current grant for the CBSD having the interference amount that has been added up immediately before the allowable amount of interference I_p is exceeded. Alternatively, as long as the cumulative amount of interference does not exceed the allowable amount of interference, it may be permitted to increase the transmission power of at least one of the CBSDs. In the example of FIG. 11, the interference amount I₁ is smallest, Ig is the next smallest, and I₂ is the largest. When I₁ is added to IR, the result is less than I_p. When I₂ is added to I₁ and Is, the result exceeds I_p. Therefore, CBSD X1 and CBSD X3 are allowed to transmit radio waves, and CBSD X2 is prohibited from using radio waves. Prohibition of use of radio waves is performed, for example, by the communication control device 130 including a response code (e.g., “SUSPENDED_GRANT” (suspension of radio wave transmission)) instructing suspension of radio wave transmission in a heartbeat response to a frequency use notification transmitted from a CBSD in the heartbeat procedure. Accordingly, the CBSD is instructed to suspend radio wave transmission with respect to the grant.

The example of interference margin allocation processing shown in FIG. 11 is an example, and other methods may be used. For example, the allowable amounts of interference (interference margin) of CBSDs X1 to X3 may be determined to be the same value or weighted values by equally allocating the allowable amount of interference at the point P or weighting and allocating it to CBSDs X1 to X3.

FIG. 12 is a diagram showing a communication relationship when pair 4 that is not synchronized with pairs 1 to 3 is present in addition to mutually synchronized pairs 1 to 3 shown in FIG. 9. Pairs 1 to 3 are synchronized with each other because TDD frames are aligned and constitute a group 200, which is one synchronized CBSD group. Further, pair 4 is not synchronized with any of pairs 1 to 3 because TDD frames for pair 4 are not aligned with pairs 1 to 3. Synchronous/asynchronous mixed type interference control (interference margin allocation processing) will be described using FIG. 12. Although there is one asynchronous pair in FIG. 12, a plurality of asynchronous pairs may be present. An asynchronous pair corresponds to a second communication device group that asynchronously communicates with one or more first communication device groups.

The processor 133 of the communication control device 130 can calculate an interference power of pair 4 in subframes of each frame of the synchronous pairs (pairs 1 to 3) when transmission timing information and the like can be acquired with respect to pair 4. Therefore, for a subframe including the transmission timing of pair 4, a cumulative interference power in the subframe can be calculated by adding the interference power of pair 4 to the cumulative interference power of pairs 1 to 3. Therefore, the subframe having the maximum cumulative interference power after the addition may be identified. The interference power of pair 4 is interference power of the CBSD that performs transmission in the corresponding subframe among the CBSDs included in pair 4. If an asynchronous pair (e.g., pair 5) other than pair 4 is further present and transmission timings are likely to overlap, the interference power of pair 5 is further added. If the transmission timings are not likely to overlap, the maximum interference power between the interference powers of pair 4 and pair 5 may be added. The interference power of pair 4 (the sum of the interference powers of pair 4, pair 5, and the like if pair 5 and the like are present) corresponds to an example of the second cumulative interference power, which is the sum of interference powers applied by one or more asynchronous pairs (second communication device group) to the protection target system.

On the other hand, in a case where there is irregularity in the transmission timing in pair 4, for example, a case where collision-based channel access which will be described later is performed, and the like, it may be difficult to calculate an interference power caused by an asynchronous pair (pair 4). That is, it is difficult to identify which of the CBSDs constituting pair 4 will perform transmission. Therefore, in the asynchronous pair (pair 4), the interference power (single-station interference power) of the CBSD that applies greater interference to the protection target system is used in calculation of the cumulative interference power for each subframe. Accordingly, it is possible to sufficiently protect the protection target system in the same manner as described above. If there is further asynchronous pair (for example, pair 5) other than pair 4, the interference power of pair 5 is further added. The interference power of pair 4 (the sum of the interference powers of pair 4 and pair 5 if pair 5 is present) corresponds to an example of second cumulative interference power which is the sum of interference powers applied by one or more asynchronous pairs (second communication device group) to the protection target system.

The communication control device 130 may define a type of group such as a synchronized CBSD group in order to easily determine which pairs are synchronized and which pair (or pair group) is asynchronous. A pair group belonging to the synchronized CBSD group is determined to be synchronized, and a pair (or pair group) which does not belong to the synchronized CBSD group is determined to be asynchronous. Information on the synchronized CBSD group is stored in the storage 136 of the communication control device 130. The information on the synchronized CBSD group may be included in CBSD group information or TDD configuration information obtained from a CBSD.

Further, if there is a group type in which synchronization requirements are imposed on CBSDs, such as a CBRS alliance coexistence group, presence or absence of synchronization may be determined on the basis of whether or not a pair belongs to the group.

If different synchronization requirements are imposed for each group, or synchronization is based on different criteria for each group, pair groups belonging to groups having the same synchronization requirements (or criteria) may be identified, and the identified pair groups may be set as synchronized pair groups. If there are a plurality of groups, the cumulative interference power for each subframe may be calculated using the same method as in FIG. 12.

In addition, the processor 133 of the communication control device (SAS) 130 may group a plurality of pairs and set the group as a synchronized pair group upon determining that the plurality of pairs are operating according to the same synchronization requirements even if group information is not signaled from the CBSD (communication device 110). As information for determination of grouping, the communication control device 130 can use, for example, synchronization reference time information, TDD format information (slot size, frame length, and the like), and the like. Any information may be used as long as it can be used to determine whether or not a plurality of pairs are synchronized.

If there is change in the TDD configuration in any pair, the processor 133 of the communication control device 130 instructs termination of the grant (TERMINATED_GRANT) or suspension of the grant (SUSPENDED_GRANT) for CBSDs of all other pair groups synchronized with the pair. In either case, CBSDs are caused to suspend radio wave transmissions based on the current grant.

It may be possible to correct parameters of grants of CBSDs instead of causing the CBSDs to suspend radio wave transmission. The reason for this is that change in the TDD configuration of any pair will change the result of calculation of the cumulative interference power. Interference control is executed on the basis of the changed TDD configuration (new TDD configuration) after the next CPAS. Therefore, the processor 133 of the communication control device (SAS) 130 may perform the following processing.

That is, the processor 133 of the communication control device (SAS) 130 calculates an interference power (single-station interference power) caused by each CBSD in advance and stores the calculated value in the storage 136. When a pair in which TDD configuration has been changed is generated, the communication control device 130 identifies the grant of a CBSD having a greater single-station interference power among CBSDs included in the pair. The calculator 132 of the communication control device 130 re-calculates the cumulative interference power of all subframes using the greater single-station interference power of the CBSD as the interference power in all subframes of the pair. In other words, the processor 133 of the communication control device 130 handles the pair in which TDD configuration has been changed as an asynchronous pair until the next interference control is executed (until the next CPAS ends). If the subframe having the maximum cumulative interference power is the same as that in the previous time, the processor 133 of the communication control device 130 may cause other pairs in which TDD configuration is not changed to continue radio wave transmission without terminating or suspending the grant. Further, if the subframe having the maximum value of cumulative interference power is changed from that in the previous time, it is desirable to instruct termination (TERMINATED_GRANT) or suspension (SUSPENDED_GRANT) of grants of CBSDs of all pairs that are synchronized with the pair or correct the grants.

In addition, if any one of CBSDs in a CBSD pair (BTS-CPE pair) is not present in the vicinity of the protection target system, that is, if it is outside the protection target area, interference control (interference margin allocation processing) of the present embodiment is not applied to the pair. In other words, it is desirable that the communication control device (SAS) 130 switch between whether to apply interference control of the present embodiment to the pair and whether to set all CBSDs as interference control targets as in the prior art by comparing location information of each CBSD pair and an interference control area. This switching is applicable to interference control described in <3.1.2>, <3.1.3>, <3.1.4>, and <3.1.5> which will be described later.

The method of calculating a cumulative interference power on the basis of whether a plurality of CBSD pairs (BTS-CPE pairs) are synchronized with each other has been described. The following procedures may be executed as modified examples.

(Modified Example 1) It is assumed that a plurality of CBSD pairs (for example, BTS-CPE pairs) are present and some pairs are not synchronized with other pairs in an interference control target area (protection target area) for a certain protection target system. In this case, the communication control device 130 instructs synchronization for some pairs (asynchronous pairs). Thereafter, the communication control device 130 executes interference control of the present embodiment (synchronous interference margin allocation processing. Refer to FIG. 9) at the time of executing interference control.

(Modified Example 2) It is assumed that a plurality of CBSD pairs (for example, BTS-CPE pairs) are present and some pairs are not synchronized with other pairs in an interference control target area for a certain protection target system. In this case, the communication control device 130 performs synchronous/asynchronous mixed type interference margin allocation processing (refer to FIG. 12) at the time of performing interference control. For example, the processor 133 of the communication control device 130 determines whether a cumulative interference power exceeds an allowable interference power through current interference margin allocation at a certain interference control execution timing, and instructs synchronization for asynchronous pairs upon determining that the cumulative interference power exceeds the allowable interference power. Thereafter, at the time of performing interference control, interference control (interference margin allocation processing) according to the present embodiment is performed. The processor 133 of the communication control device 130 determines grant parameters on the basis of an interference margin re-allocated to each CBSD and assigns grants to CBSDs.

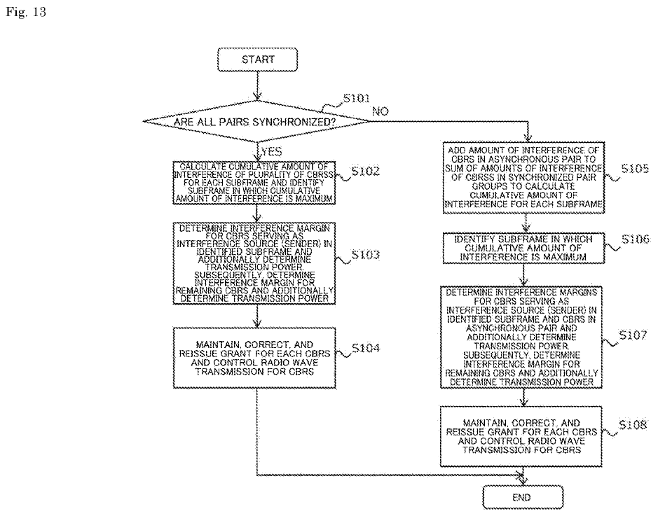

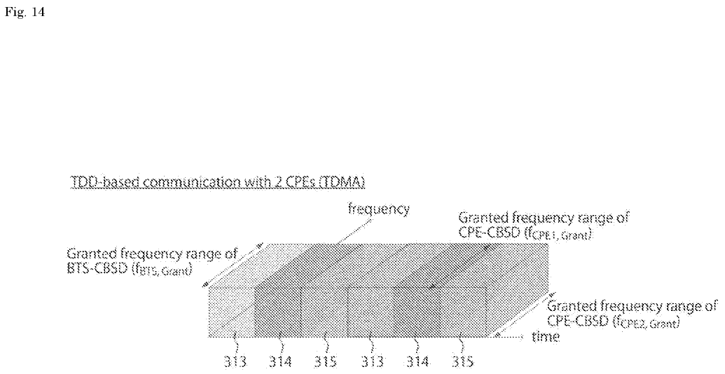

FIG. 13 is a flowchart of an example of the operation of the communication control device 130 according to the present embodiment. The processor 133 of the communication control device 130 determines whether or not all of a plurality of CBSD pairs are synchronized (S101). If all pairs are synchronized, synchronous interference control described with reference to FIG. 9 is performed. That is, the processor 133 calculates the cumulative amount of interference of a plurality of CBRSs for each subframe and identifies a subframe having the maximum value (S102). A CBRS that is an interference source (sender) in the identified subframe is identified from each pair, an interference margin for each identified CBRS is determined, and a transmission power is further determined (S103). Next, an interference margin for the remaining CBRS of each pair is determined on the basis of the interference margin for each identified CBRS, and the transmission power is further determined (S103). The processor 133 maintains, corrects, or reissues the grant for each CBRS, and controls radio wave transmission for CBRSs according to the determined details (S104).

If two or more pairs on one side are synchronized and the other pairs are not synchronized, synchronous/asynchronous mixed interference control described with reference to FIG. 12 is performed. That is, the processor 133 sums interference amounts of a plurality of CBRSs in synchronized pair groups for each subframe, and adds the interference amount of a CBRS having a greater interference power in an asynchronous pair to calculate the cumulative amount of interference (S105). A subframe having the maximum value of cumulative interference amount is identified (S106). A CBRS that is an interference source (sender) in the identified subframe is identified from each synchronized pair, interference margins for each identified CBRS and a CBRS having a greater interference power in the aforementioned asynchronous pair are determined, and transmission power is further determined (S107). Next, an interference margin for the remaining CBRS in each pair (synchronous pair, asynchronous pair) is determined, and the transmission power is further determined (S107). The processor 133 maintains, corrects, or reissues the grant for each CBRS, and controls radio wave transmission for CBRSs according to the determined details (S108). If two or more pairs on one side are synchronized and the other pairs are not synchronized, synchronous/asynchronous mixed interference control described with reference to FIG. 12 is performed. If it is possible to acquire transmission timing information and the like of an asynchronous pair, the cumulative amount of interference may be calculated using the interference power of a CBSD that performs transmission between CBSDs of the asynchronous pair for a time corresponding to transmission timing information in subframes.

<3.1.2 Case where Multiple CPE-CBSDs are Multiplexed on Time Axis>

FIG. 14 is a diagram showing a relationship between frequency and time when a single BTS-CBSD communicates with a plurality of CPE-CBSDs on a TDD basis. That is, the plurality of CPE-CBSDs are multiplexed on the time axis (TDMA: Time Division Multiple Access). The number of members of one communication device group (CBSD group) is three.

In FIG. 14, a granted frequency range (f_{BTS, Grant}) is a frequency band (frequency range) based on a grant in which the BTS-CBSD is approved by the SAS. A granted frequency range (f_{CPE1, Grant}) is a frequency band (frequency range) based on a grant in which one CPE-CBSD is approved by the SAS. A granted frequency range (f_{CPE2, Grant}) is a frequency band (frequency range) based on a grant in which the other CPE-CBSD is approved by the SAS. The BTS CBSD uses time resources (subframes) 313. In the two CPE CBSDs, one CPE CBSD uses time resources (subframes) 314 and the other CPE CBSD uses time resources (subframes) 315. The time resources 313 to 315 are repeated in sequence.

Since the BTS-CBSD communicates with two CPE-CBSDs through TDMA, these three CBSDs do not radiate radio waves at the same time on the time axis. That is, radio waves of the same frequency are alternately radiated in the time resources 311, time resources 312, and time resources 313 that are alternately repeated. It is desirable that the BTS-CBSD provide resource scheduling information of the time axis to the communication control device (SAS) 130.

At this time, interference control (interference margin allocation processing) can be performed by the same method as the method (method in <3.1.1>) used when the BTS-CBSD communicates with a single CPE-CBSD on a TDD basis. That is, although the CBSD group includes two CBSDs in the method described above, the CBSD group includes three CBSDs (BTS_CBSD and two CPE_CBSDs) in this example. On the assumption that the CBSD group including the three CBSDs is synchronized with another CBSD group (including two or more CBSDs), the above-described method shown in FIG. 9 is used. If there is a CBSD group that is not synchronized with another CBSD group, the method shown in FIG. 12 may be applied. It is desirable that the BTS-CBSD provide resource scheduling information of the time axis to the communication control device (SAS) 130.

<3.1.3 Case where Multiple CPE-CBSDs are Multiplexed on Frequency Axis>

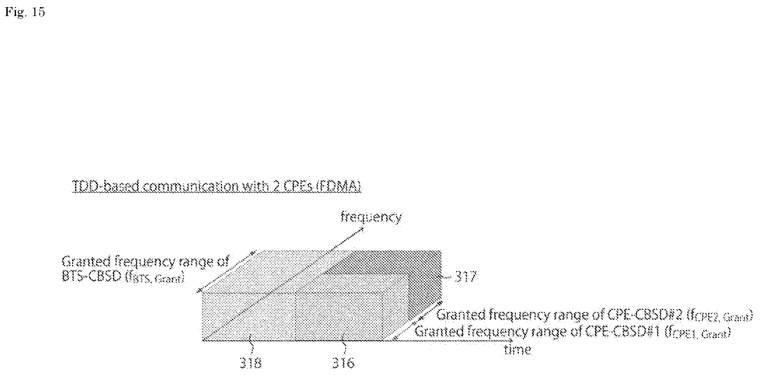

FIG. 15 is a diagram showing a relationship between frequency and time when a BTS-CBSD communicates with a plurality of CPE-CBSDs on a TDD basis in frequency division multiple access (FDMA).

In FIG. 15, a granted frequency range (f_{BTS, Grant}) is a frequency band (frequency range) based on a grant in which the BTS-CBSD is approved by the SAS. A granted frequency range (f_{CPE1, Grant}) is a frequency band (frequency range) based on a grant in which one CPE-CBSD (CPE-CBSD #1) of two CPE CBSDs is approved by the SAS. A granted frequency range (f_{CPE2, Grant}) is a frequency band (frequency range) based on a grant in which the other CPE-CBSD (CPE-CBSD #2) is approved by the SAS. The BTS CBSD uses a time resource 318, CPE CBSD #1 uses a time resource 316 and CPE-CBSD #2 uses a time resource 317. The time resources 316 and 317 have the same location, but they occupy different frequency ranges.

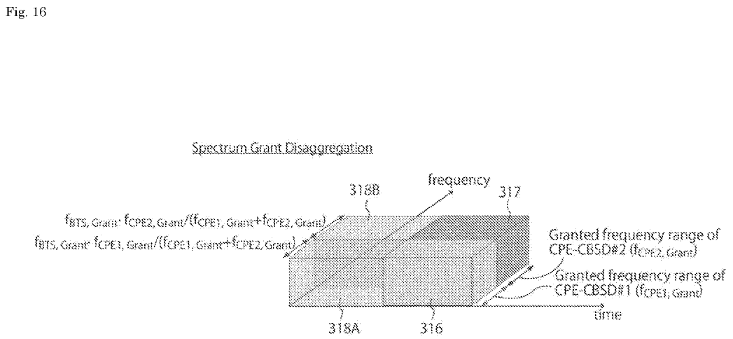

At this time, interference control (interference margin allocation processing) can be performed using the same method as the method (method in <3.1.1>) used when the BTS-CBSD communicates with a single CPE-CBSD on a TDD basis. At the time of calculating a cumulative interference power, it is possible to easily calculate the amount of interference caused by the CBSD group by dividing the grant of the BTS-CBSD in accordance with the frequency bands of grants of CPE CBSD #1 and CPE-CBSD #2. A specific description will be given with reference to FIG. 16.

FIG. 16 schematically shows an example of dividing the grant of the BTS-CBSD in accordance with the frequency ranges of the grants of CPE CBSD #1 and CPE-CBSD #2. The grant of the BTS-CBSD is divided into a grant (grant 1) of a frequency range according to the granted frequency range (f_{CPE1, Grant}) and a grant (grant 2) of a frequency range according to the granted frequency range (f_{CPE2, Grant}). The frequency range of grant 1 is represented as f_{BTS,Grant} f_{CPE1,Grant}/(f_{CPE1,Grant}+f_{CPD2,Grant}). The frequency range of grant 2 is represented as f_{BTS,Grant} f_{CPE2,Grant}/(f_{CPE1,Grant}+f_{CPD2,Grant}). A time resource 318A of grant 1 and a time resource 318B of grant 2 have the same location, but they occupy different frequency ranges.

Accordingly, for the grants of CPE CBSD #1 and CPE-CBSD #2, a model (model shown in <3.1.1>) in which a single CPE-CBSD communicates with the BTS-CBSD in the frequency range based on grant 1 and the frequency range based on grant 2 may be conceived. For the grant of the BTS-CBSD, the amount of interference during transmission from the BTS-CBSD to CPE-CBSD #1 and CPE-CBSD #2 may be the sum of the amount of interference during transmission to CPE-CBSD #1 and the amount of interference during transmission to CPE-CBSD #2 in calculation of a cumulative interference power. Further, as the amount of interference during transmission from CPE-CBSD #1 and CPE-CBSD #2 to the BTS-CBSD, the sum of the amount of interference during transmission to CPE-CBSD #1 and the amount of interference during transmission to CPE-CBSD #2 may be used.

<3.1.4 Case where Multiple CPE-CBSDs are Multiplexed on Spatial Axis>

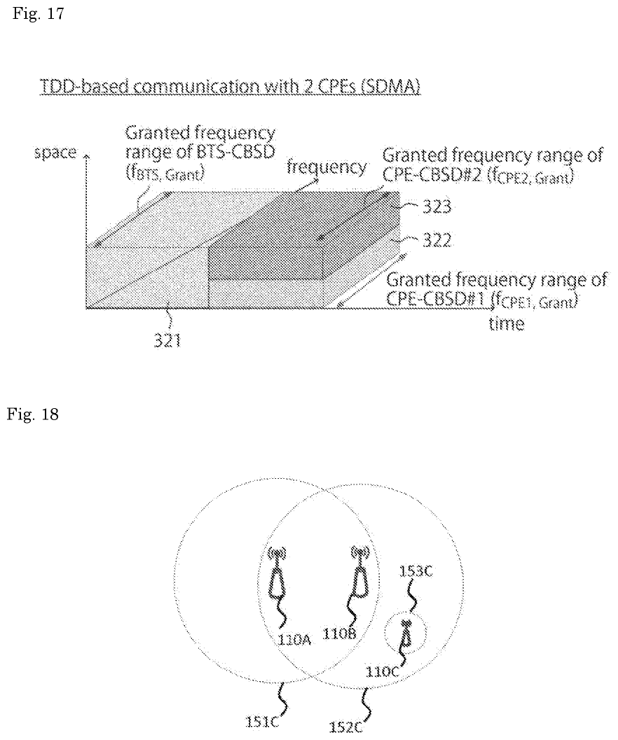

FIG. 17 is a diagram showing a relationship between space, frequency, and time when a BTS-CBSD communicates with a plurality of CPE-CBSDs on a TDD basis in spatial division multiple access (SDMA).

In FIG. 17, a granted frequency range (f_{BTS, Grant}) is a frequency band (frequency range) based on a grant in which the BTS-CBSD is approved by the SAS. A granted frequency range (f_{CPE1, Grant}) is a frequency band (frequency range) based on a grant in which one CPE-CBSD (CPE-CBSD #1) of two CPE CBSDs is approved by the SAS. A granted frequency range (f_{CPE2, Grant}) is a frequency band (frequency range) based on a grant in which the other CPE-CBSD (CPE-CBSD #2) is approved by the SAS. f_{BTS}, f_{CPE1}, and f_{CPE2} are the same frequency range. The BTS CBSD uses a time resource 321, CPE-CBSD #1 uses a time resource 322, and CPE-CBSD #2 uses a time resource 323. The time resources 322 and 323 have the same location, but they occupy different spaces (e.g., spatial codes, beam patterns, or the like).

Basically, it is possible to perform interference control (interference margin allocation processing) by the same method as the model in which a single CPE-CBSD communicates with the BTS-CBSD (model shown in <3.1.1>). However, since a plurality of CPE-CBSDs can simultaneously communicate with the BTS-CBSD in the same time (subframe), the multiplexed CPE-CBSD #1 and CPE-CBSD #2 are handled as transmitting radio waves simultaneously in calculation of a cumulative interference power in the same time. That is, the amount of interference during transmission from CPE-CBSD #1 and CPE-CBSD #2 to BTS-CBSD in a subframe is the sum of the amounts of interference of CPE-CBSD #1 and CPE-CBSD #2.

### Modified Example

A synchronized pair or an asynchronous pair may use a communication scheme that combines two or more of the above-described time multiple communication, frequency multiplex communication, and spatial multiplex communication.

<3.1.5 Case where Collision-Based Channel Access is Performed>

FIG. 18 shows an arrangement example of a plurality of communication devices that can interfere with each other. In wireless system models such as CBRS, it is assumed that collision-based channel access represented by CSMA/CA or LBT is performed in communication between CBSDs (communication devices 110). An example of a case in which a group of communication devices that perform collision-based channel access is present as an asynchronous group described above will be described.

In channel access based on power detection, a communication device performs carrier sensing before emitting radio waves to a radio medium to determine whether a power exceeding a predetermined threshold value is detected. Whether or not to radiate radio waves is determined on the basis of the determination result. On the basis of this operation, the processor 133 of the communication control device 130 determines whether or not communication devices 110 are in a relationship in which they can interfere with each other (whether or not radio waves are mutually detectable) and constructs a graph on the basis of the determination result.

In FIG. 18, some or all coverages (calculated on the basis of a power detection threshold value) 151C and 152C in a pair of communication devices 110A and 110B overlap mutual communication devices. The coverage 152C of the communication device 110B includes a communication device 110C and its coverage 153C. In this case, the communication devices are likely to detect power exceeding the threshold value. There are other examples of relationships in which communication devices can cause mutual interference. For example, it may be determined whether or not there is a relationship in which communication devices can cause mutual interference on the basis of the ratio of an overlapping portion to a non-overlapping portion between coverages. If there is merely a small overlapping area of coverages, it may be determined that there is a relationship in which mutual interference can occur. Further, in an overlapping portion of coverages, if the probability that an interference power value exceeds a predetermined interference threshold value (location rate, time rate, and the like) exceeds a predetermined threshold probability, it may be determined that there is a relationship in which mutual interference can occur.

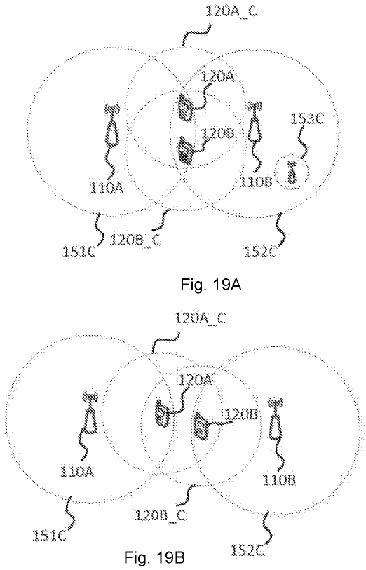

FIG. 19(A) and FIG. 19(B) show other arrangement examples of a plurality of communication devices that may interfere with each other. The communication device 110A communicates with a terminal device 120A, and the communication device 110B communicates with a terminal device 120B. The communication device 110B is a non-serving communication device for the terminal device 120A, and the communication device 110A is a non-serving communication device for the terminal device 120B. The radio coverage ranges 120A_C and 120B_C of the terminal devices 120A and 120B partially or fully overlap with the coverages of non-serving communication devices. In the example of FIG. 19(B), the coverages 151C and 152C of the communication devices 110A and 110B do not overlap directly, but they overlap indirectly through the coverages 120A_C and 120B_C of the terminals 120A and 120B. In this case, it may also be determined that the communication devices may interfere with each other. However, in a case where a common network with the same SSID and cell ID is formed, a case where a distributed antenna system (DAS) is formed, and the like, it may be determined that communication devices do not interfere with each other.

It is desirable that a coverage be determined by the power detection threshold value. More generally, it is desirable that a coverage be determined by metric on which channel access is based.

The processor 133 of the communication control device 130 (for example, SAS) acquires metric information of each communication device and divides communication devices into a plurality of communication device groups. In individual communication device groups (groups), communication devices are in a relationship in which they do not mutually detect radio waves (there is a possibility that radio waves are transmitted at the same time). It is assumed that radio waves are not radiated simultaneously between groups. The communication control device 130 may acquire the metric information from the communication device 110 or the like, or the metric information may be stored in the storage 136 in advance.

The processor 133 of the communication control device 130 may generate a graph connecting communication devices capable of mutually detecting radio waves to generate communication device groups (groups) that do not detect radio waves within each group. The graph is generated for each frequency between communication devices using the same frequency. The processor 133 of the communication control device 130 may transmit information on the generated graph to a device of an administrator.

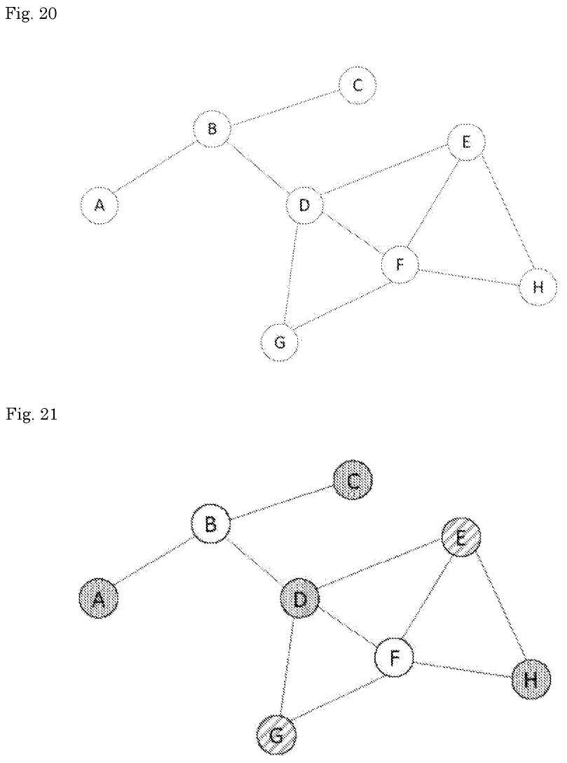

FIG. 20 shows an example of a graph generated by the processor 133 of the communication control device 130. This graph is a graph connecting communication devices capable of detecting radio waves.

Each vertex indicates a communication device 110. The alphabet at each vertex is a code for identifying the communication device. A link connecting vertices means that communication devices corresponding to vertices at both ends are in a relationship in which they can mutually detect radio waves. The processor 133 of the communication control device 130 identifies communication devices that are not in a relationship in which they mutually detect radio waves on the basis of the generated graph and groups the identified plurality of communication devices into one. Specifically, a group including four communication devices corresponding to vertices A, C, D, and H (“group ACDH”), a group including two communication devices corresponding to vertices B and F (“group BF”), and a group including two communication devices corresponding to vertices E and G (“group EG”) are generated.

FIG. 21 is a diagram showing the vertices of the same group in the graph of FIG. 20 in the same pattern. The processor 133 of the communication control device 130 may transmit information on the graph in such a pattern to the device of the administrator.

The graph in FIG. 20 or FIG. 21 is a graph of one connected set, but graphs of a plurality of connected sets may be generated.

The calculator 132 of the communication control device 130 calculates a cumulative interference power (for example, a maximum cumulative interference power) that can be applied to the protection target system for each of the three groups (group ACDH, group BF, and group EG). Due to the nature of channel access, it is assumed that the groups (group ACDH, group BF, and group EG) do not perform transmission at the same time.

The processor 133 of the communication control device 130 can handle the connected set as an asynchronous group (channel access group) in the examples such as <3.1.1> described above. As an example, the maximum value of cumulative interference power of each group in the connected set is calculated and added to cumulative interference powers of a plurality of synchronization pairs in subframes described in <3.1.1> and the like to calculate cumulative interference powers of the subframes. Then, a subframe with the maximum value of the calculated cumulative interference powers is identified. In the identified subframe, an interference margin of a communication device that has performed transmission in synchronized groups and an interference margin of a communication device belonging to the group for which the aforementioned maximum value has been calculated among the groups in the connected set are determined. Furthermore, it is possible to determine interference margins of other groups (channel access groups) and other communication devices in the synchronization groups on the basis of the determined interference margins. Communication devices in the same channel access group may have the same interference margin. If there are a plurality of connected sets (corresponding to a case where there are a plurality of second communication device groups performing random access), each connected set may be handled as an independent asynchronous group.

### Modified Example

In the above example, the case where an asynchronous group described in <3.1.1> and the like is a connected set including a plurality of collision-based channel access groups has been described. As another example, when there are only a plurality of collision-based channel access groups in a connected set (assuming a situation where no synchronized group is present), inter-group interference control (interference margin allocation processing) can also be performed with the same concept as described in <3.1.1> and the like.

In this case, the calculator 132 of the communication control device 130 calculates a cumulative interference power (for example, a maximum interference power) that can be applied to the protection target system for each collision-based channel access group in the connected set. The processor 133 determines an interference margin for a communication device for each group on the basis of the cumulative interference power calculated for each group. The interference margin for the communication device in each group is determined such that the sum of the interference margins for communication devices that can perform transmission at the same time within a group is equal to or less than an allowable interference power of the protection target system.

If there are a plurality of connected sets, the following operation may be performed. That is, the processor 133 of the communication control device 130 compares cumulative interference powers between groups for each connected set and identifies a maximum cumulative interference power. The processor 133 of the communication control device 130 sets the sum of maximum cumulative interference powers of each connected set as a maximum cumulative interference power that can be applied to the protection target system. In other words, this operation corresponds to creating a Keep List or performing IAP or the like on the basis of the cumulative interference power in connected set units. The processor 133 determines an interference margin for each connected set. Furthermore, an interference margin for a communication device in each group (channel access group) is determined by allocating the interference margin determined for each connected set.

According to this example and the above-described modified example, if there are a plurality of communication devices that perform collision-based channel access, it is possible to effectively determine an interference margin for each group by creating a plurality of groups which do not perform mutual radio wave detection (can perform transmission at the same time) in respective groups. Accordingly, the secondary availability of a frequency band assigned to a wireless system (primary system or the like) can be enhanced.

Meanwhile, collision-based channel access may be synchronous or asynchronous. Further, multiplexing on a different axis such as SDMA or FDMA may be performed by combining the above-described methods. Multiplexing on a different axis can be used, for example, as an index for determining that there is no mutual interference, as described above.

Further, although a graph or a connected set has been generated for the purpose of interference control (interference margin allocation processing) in this example, it is also possible to use a generated graph or the like for the purpose of coexistence between communication devices. Alternatively, conversely, it is also possible to create a graph or a connected set for the purpose of coexistence between communication devices and use the created graph or the like for the aforementioned interference control (interference margin allocation processing). Accordingly, it is possible to effectively achieve both interference control and coexistence control.

It should be noted that the above-described embodiments show examples for embodying the present disclosure, and the present disclosure can be implemented in various other forms. For example, various modifications, substitutions, omissions, or combinations thereof are possible without departing from the gist of the present disclosure. Such forms of modifications, substitutions, and omissions are included in the scope of the invention described in the claims and the scope of equivalence thereof, as included in the scope of the present disclosure.

In addition, the effects of the present disclosure described herein are merely exemplary and may have other effects.

The present disclosure can have the following configuration.

### [Item 1]

A communication control device including:
a calculator by which one or more first communication device groups for which a plurality of first time resources for communication are synchronized with each other calculate a first cumulative interference power, which is the sum of interference powers applied to a protection target system, in units of the first time resources; and
a processor configured to determine an interference margin indicating an interference power allowable for communication devices of the one or more first communication device groups on the basis of the first cumulative interference power.

### [Item 2]

The communication control device according to item 1, wherein the processor determines the interference margin as a value allowing the sum of interference powers of communication devices performing transmission using the first time resources in the one or more first communication device groups to become equal to or less than the allowable interference power of the protection target system.

### [Item 3]

The communication control device according to item 2, wherein the processor detects a first time resource in which the first cumulative interference power is maximum among the plurality of first time resources, and
determines the interference margin on the basis of the first cumulative interference power in the first time resource.

### [Item 4]

The communication control device according to any one of items 1 to 3, wherein the processor determines a transmission power allowed for the communication devices on the basis of the interference margin.

### [Item 5]

The communication control device according to any one of items 1 to 4, wherein at least one of the first communication device groups performs time division communication.

### [Item 6]

The communication control device according to any one of items 1 to 5, wherein at least one of the first communication device groups performs frequency multiplex communication.

### [Item 7]

The communication control device according to any one of items 1 to 6, wherein at least one of the first communication device groups performs spatial multiplex communication.

### [Item 8]

The communication control device according to any one of items 1 to 7, wherein the calculator is used for one or more second communication device groups asynchronously communicating with the one or more first communication device groups to calculate a second cumulative interference power, which is the sum of interference powers applied to the protection target system, and
the processor determines interference margins indicating interference powers allowable for the communication devices of the first communication device groups and communication devices of the second communication device groups on the basis of the first cumulative interference power and the second cumulative interference power.

### [Item 9]

The communication control device according to item 8, wherein the processor detects a first time resource in which the first cumulative interference power is maximum among the plurality of first time resources, and
determines the interference margins on the basis of the first cumulative interference power and the second cumulative interference power in the detected first time resource.

### [Item 10]

The communication control device according to item 9, wherein the processor determines the interference margins on the basis of the first cumulative interference power and a maximum value of the second cumulative interference power in the detected first time resource.

### [Item 11]

The communication control device according to any one of items 8 to 10, wherein the processor calculates the second cumulative interference power at a time corresponding to the first time resource on the basis of transmission timing information of the second communication device groups,
the processor detects a first time resource in which the sum of the first cumulative interference power and the second cumulative interference power is maximum, and
determines the interference margins on the basis of the first cumulative interference power and the second cumulative interference power in the detected first time resource.

### [Item 12]

The communication control device according to any one of items 8 to 11, wherein the second communication device groups include a plurality of communication devices performing communication according to collision-based channel access, the processor divides the plurality of communication devices into a plurality of groups in a relationship in which communication devices belonging to the same group do not detect mutual radio waves,
the calculator sets the sum of interference powers applied to the protection target system by the groups as the second cumulative interference power, and
the processor determines the interference margins on the basis of the first cumulative interference power and the second cumulative interference power for each group.

### [Item 13]

The communication control device according to item 12, wherein the processor determines the interference margins on the basis of a maximum value of the second cumulative interference power for each group.

### [Item 14]

The communication control device according to item 13, wherein there are a plurality of second communication device groups, and
the interference margins are determined on the basis of the sum of maximum values of the second cumulative interference powers for respective second communication device groups.

### [Item 15]

The communication control device according to any one of items 8 to 14, wherein the processor determines a transmission power allowed for the communication devices of the first communication device groups and the communication devices of the second communication device groups on the basis of the interference margins.

### [Item 16]

The communication control device according to any one of items 8 to 15, wherein at least one of the second communication device groups performs time division communication.

### [Item 17]

The communication control device according to any one of items 8 to 16, wherein at least one of the second communication device groups performs frequency multiplex communication.

### [Item 18]

The communication control device according to any one of items 8 to 17, wherein at least two first communication device groups among the second communication device groups perform spatial multiplex communication.

### [Item 19]

A communication control device including a processor configured to divide a plurality of communication devices performing communication according to collision-based channel access into a plurality of groups in a relationship in which communication devices belonging to the same group do not detect mutual radio waves, and a calculator configured to calculate a cumulative interference power, which is the sum of interference powers applied by the groups to a protection target system,
wherein the processor determines an interference margin for communication devices belonging to the groups on the basis of the cumulative interference power for each group.

### [Item 20]

A communication control method including: calculating, by one or more first communication device groups for which a plurality of first time resources for communication are synchronized with each other, a first cumulative interference power which is the sum of interference powers applied to a protection target system in units of the first time resources; and
determining an interference margin indicating interference power allowable for communication devices of the one or more first communication device groups on the basis of the first cumulative interference power.

### [Item 21]

A communication device in one or more first communication device groups for which a plurality of first time resources for communication are synchronized with each other, wherein
the sum of an interference power applied to a protection target system by radio waves transmitted by the communication device using an arbitrary first time resource among the plurality of first time resources and an interference power applied to the protection target system by radio waves transmitted by another communication device in the first communication device groups using the arbitrary first time resource is equal to or less than an interference power value allowed for the protection target system.

### REFERENCE SIGNS LIST

131 Receiver
132 Calculator
133 Processor
134 Transmitter
135 Controller
136 Storage
137 Detector
111 Receiver
113 Processor
114 Transmitter
115 Controller
116 Storage
100 Communication network
110, 110A, 110B, 110C Communication device
120, 120A Terminal
130, 130A, 130B Communication control device
110, 110A, 110B, 110C Communication device
130 Communication control device
110A, 110B Communication device
120C, 151C, 152C Coverage
311, 312, 313, 314, 315, 316, 317, 318, 318A, 318B, 321, 322, 323 Time resource

1. A communication control device including:
a calculator by which one or more first communication device groups for which a plurality of first time resources for communication are synchronized with each other calculate a first cumulative interference power, which is the sum of interference powers applied to a protection target system, in units of the first time resources; and
a processor configured to determine an interference margin indicating an interference power allowable for communication devices of the one or more first communication device groups on the basis of the first cumulative interference power.

2. The communication control device according to claim 1, wherein the processor determines the interference margin as a value allowing the sum of interference powers of communication devices performing transmission using the first time resources in the one or more first communication device groups to become equal to or less than the allowable interference power of the protection target system.

3. The communication control device according to claim 2, wherein the processor detects a first time resource in which the first cumulative interference power is maximum among the plurality of first time resources, and
determines the interference margin on the basis of the first cumulative interference power in the first time resource.

4. The communication control device according to claim 1, wherein the processor determines a transmission power allowed for the communication devices on the basis of the interference margin.

5. The communication control device according to claim 1, wherein at least one of the first communication device groups performs time division communication.

6. The communication control device according to claim 1, wherein at least one of the first communication device groups performs frequency multiplex communication.

7. The communication control device according to claim 1, wherein at least one of the first communication device groups performs spatial multiplex communication.

8. The communication control device according to claim 1, wherein the calculator is used for one or more second communication device groups asynchronously communicating with the one or more first communication device groups to calculate a second cumulative interference power, which is the sum of interference powers applied to the protection target system, and
the processor determines interference margins indicating interference powers allowable for the communication devices of the first communication device groups and communication devices of the second communication device groups on the basis of the first cumulative interference power and the second cumulative interference power.

9. The communication control device according to claim 8, wherein the processor detects a first time resource in which the first cumulative interference power is maximum among the plurality of first time resources, and
determines the interference margins on the basis of the first cumulative interference power and the second cumulative interference power in the detected first time resource.

10. The communication control device according to claim 9, wherein the processor determines the interference margins on the basis of the first cumulative interference power and a maximum value of the second cumulative interference power in the detected first time resource.

11. The communication control device according to claim 8, wherein the processor calculates the second cumulative interference power at a time corresponding to the first time resource on the basis of transmission timing information of the second communication device groups,
the processor detects a first time resource in which the sum of the first cumulative interference power and the second cumulative interference power is maximum, and
determines the interference margins on the basis of the first cumulative interference power and the second cumulative interference power in the detected first time resource.

12. The communication control device according to claim 8, wherein the second communication device groups include a plurality of communication devices performing communication according to collision-based channel access,
the processor divides the plurality of communication devices into a plurality of groups in a relationship in which communication devices belonging to the same group do not detect mutual radio waves,
the calculator sets the sum of interference powers applied to the protection target system by the groups as the second cumulative interference power, and
the processor determines the interference margins on the basis of the first cumulative interference power and the second cumulative interference power for each group.

13. The communication control device according to claim 12, wherein the processor determines the interference margins on the basis of a maximum value of the second cumulative interference power for each group.

14. The communication control device according to claim 13, wherein there are a plurality of second communication device groups, and
the interference margins are determined on the basis of the sum of maximum values of the second cumulative interference powers for respective second communication device groups.

15. The communication control device according to according to claim 8, wherein the processor determines a transmission power allowed for the communication devices of the first communication device groups and the communication devices of the second communication device groups on the basis of the interference margins.

16. The communication control device according to claim 8, wherein at least one of the second communication device groups performs time division communication.

17. The communication control device according to claim 8, wherein at least one of the second communication device groups performs frequency multiplex communication.

18. The communication control device according to claim 8, wherein at least two first communication device groups among the second communication device groups perform spatial multiplex communication.

19. A communication control device including a processor configured to divide a plurality of communication devices performing communication according to collision-based channel access into a plurality of groups in a relationship in which communication devices belonging to the same group do not detect mutual radio waves, and a calculator configured to calculate a cumulative interference power, which is the sum of interference powers applied by the groups to a protection target system,
wherein the processor determines an interference margin for communication devices belonging to the groups on the basis of the cumulative interference power for each group.

20. A communication control method including: calculating, by one or more first communication device groups for which a plurality of first time resources for communication are synchronized with each other, a first cumulative interference power which is the sum of interference powers applied to a protection target system in units of the first time resources; and
determining an interference margin indicating an interference power allowable for communication devices of the one or more first communication device groups on the basis of the first cumulative interference power.

21. A communication device in one or more first communication device groups for which a plurality of first time resources for communication are synchronized with each other, wherein
the sum of an interference power applied to a protection target system by radio waves transmitted by the communication device using an arbitrary first time resource among the plurality of first time resources and an interference power applied to the protection target system by radio waves transmitted by another communication device in the first communication device groups using the arbitrary first time resource is equal to or less than an interference power value allowed for the protection target system.
